(19) United States
(12) Patent Application Publication
(10) Pub. No.: US 2003/0195329 A1
(43) Pub. Date: Oct. 16, 2003

(54) Aromatic polycarbonate, composition thereof , and use

(76) Inventors: Wataru Funakoshi, Yamaguchi (JP); Hiroaki Kaneko, Yamaguchi (JP); Takanori Miyoshi, Yamaguchi (JP); Yuichi Kageyama, Yamaguchi (JP); Katsushi Sasaki, Yamaguchi (JP)

Correspondence Address: SUGHRUE MION, PLLC, 2100 PENNSYLVANIA AVENUE, N.W., WASHINGTON, DC, 20037, US

(21) Appl. No.: 10/296,994

(22) PCT Filed: May 30, 2001
(86) PCT No.: PCT/JP01/04556

(30) Foreign Application Priority Data
Jun. 1, 2000 (JP) 2000-164531
Aug. 16, 2000 (JP) 2000-246723

(51) Int. Cl. C08G 64/00

(52) U.S. Cl. 528/370

(57) ABSTRACT

An aromatic polycarbonate which has a low radical concentration and retains a good color, transparency, durability and stability even after it is kept under high temperature and high humidity for a long time and a composition thereof. The polycarbonate and composition are advantageously used in an optical disk substrate.

### FIELD OF THE INVENTION

The present invention relates to an aromatic polycarbonate, composition and use thereof in the optical field. More specifically, it relates to an aromatic polycarbonate which exhibits a good color, high durability and excellent stability particularly when it is used at a high temperature and high humidity for a long time and is suitable for forming a precision molded article for use in the optical field, composition and use thereof in the optical field.

### DESCRIPTION OF THE PRIOR ART

Aromatic polycarbonates are engineering plastics excellent in color, transparency, dimensional stability and impact resistance. Since the further improvement of color and transparency thereof and the controllability of variations in color and transparency have been called for and use environmental conditions have been expanding in recent years due to diversified application of the aromatic polycarbonates, high environmental durability which enables the aromatic polycarbonates to retain the above features even when they are used under high temperature and high humidity for a long time is required of the aromatic polycarbonates.

In addition, polycarbonate resin compositions are frequently used for the production of precision molded articles such as optical disk substrates, and color, transparency and transferability are important quality items.

With a recent tendency toward growing density, increasing capacity and decreasing thickness of optical recording media, requirements for excellent transferability which enables the accurate reproduction of the shape of a mold stamper has been becoming higher and higher. Therefore, a substrate material having high transferability which makes it possible to obtain sufficiently high reliability has been desired.

Accordingly, it is hardly said that molded articles obtained from conventional aromatic polycarbonates are satisfactory in terms of color and transparency and they experience deterioration such as a reduction in molecular weight, worsened color, fluctuations in color and transparency and whitening at high temperature and high humidity for a long time, thereby causing a problem with environmental durability. In addition, the thickness of a substrate for the lately proposed DVD-RAM has been reduced from conventional 1.2 mm to 0.6 mm, whereby transferability attracts much attention as an important factor to be taken into consideration.

Since the thickness of the substrate has been reduced from 1.2 mm to 0.6 mm, at the time of injection molding the substrate, the distance between the surface of a mold and the substrate becomes small and the temperature of a resin greatly drops while the resin moves from the interior to the exterior of the substrate in the cavity of the substrate. As a result, the transferability of the peripheral portion of the substrate greatly deteriorates. To solve this problem, a technology for reducing the molecular weight of a polymer which is used to produce a conventional 1.2 mm thick substrate or a technology for increasing the temperature of a resin used for the production of a 1.2 mm thick substrate from 340° C. to 380° C. to mold a 0.6 mm thick substrate is widely used. When the molecular weight is reduced, there may arise such a new problem as a reduction in the mechanical strength of a molded article and higher heat resistance is required of a polycarbonate and a polycarbonate resin composition to increase the temperature of the resin at the time of molding.

A reduction in the molecular weight of a polymer caused by environmental conditions deteriorates the mechanical properties such as impact resistance of a substrate having a small thickness and growing fluctuations or deterioration in the color and transparency detracts the advantage of using an aromatic polycarbonate from a general molded article. Especially deterioration or fluctuations in color and transparency cause a problem with reliability of recording and reproduction in a disk substrate material.

Since it is apprehended that deterioration in an aromatic polycarbonate under high temperature and high humidity, such as a reduction in molecular weight, worsened color or whitening, is caused by trace amounts of impurities contained in the polymer, particularly metal compounds (the definite chemical structures of existent chemical specifies are unknown), some proposals have been made on the method of purifying raw materials and a polymer and the effect on heat resistant stability of reducing the contents of metals but a perfect solution has not been found yet.

JP-A 5-148355 (the term “JP-A” as used herein means an “unexamined published Japanese patent application”) discloses the effect of reducing the contents of metals on the heat resistant stability, particularly the improvement of coloring of an aromatic polycarbonate. Metal elements which are taken into consideration are only iron and sodium, the content of iron is 5 ppm or less, and that of sodium is 1 ppm or less. JP-A 6-32885 discloses a polycarbonate which is excellent in color and transparency and has a total content of iron, chromium and molybdenum of 10 ppm or less and a total content of nickel and copper of 50 ppm or less. The content of nickel in the polymer is 1 ppm and that of copper is 1 ppm in Examples in which the optimum conditions are realized of this specification. Thus, the contents of these metal elements are high.

JP-A 9-183895 discloses a polycarbonate obtained from an aromatic dihydroxy compound having a total content of iron, chromium and nickel of 0 to 50 ppb but it is utterly silent about other metal species and the relationship between the amount of the used catalyst and the amounts of impurities.

In contrast to this, JP-A 11-310630 has aimed to improve a gel and the color and heat resistant stability of an aromatic polycarbonate produced by reducing the content of iron out of metal impurities to 10 ppb and the total content of chroman-based impurities to 40 ppm and has achieved some results.

However, the stability of the polymer cannot be achieved simply by reducing the contents of metal impurities. It is important that characteristic properties which have an influence upon the stability of an aromatic polycarbonate molecular structure and important factors which have an influence on other stabilities should be found and measures should be taken. Heretofore, attempts have been made simply to reduce the number of terminal phenolic hydroxyl groups to this end.

### SUMMARY OF THE INVENTION

It is an object of the present invention to provide an aromatic polycarbonate which exhibits a good color, high durability and excellent stability even when it is used under high temperature and high humidity for a long time.

It is another object of the present invention to provide an aromatic polycarbonate which has excellent durability and excellent stability so that it can retain a good color, excellent transparency and mechanical strength for a long time.

It is still another object of the present invention to provide an aromatic polycarbonate which has the above characteristic properties improved to such a level that cannot be attained by the prior art and excellent environment resistant stability.

It is a further object of the present invention to provide an aromatic polycarbonate which is suitable for precision molding, particularly the precision molding of a molded article for use in the optical field, and has excellent transferability at the time of molding.

It is a still further object of the present invention to provide an aromatic polycarbonate composition which comprises the above aromatic polycarbonate of the present invention and has excellent heat resistant stability at the time of molding.

It is a still further object of the present invention to provide a molded article, particularly a precision molded article for use in the optical field, made from the aromatic polycarbonate or aromatic polycarbonate composition of the present invention.

Other objects and advantages of the present invention will become apparent from the following description.

According to the present invention, firstly, the above objects and advantages of the present invention are attained by an aromatic polycarbonate (may be referred to as “first aromatic polycarbonate” hereinafter) which comprises (A) a recurring unit represented by the following formula (a):

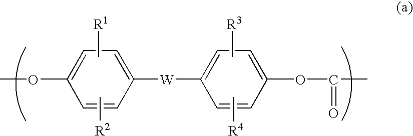

wherein R¹, R², R³ and R⁴ are each independently a hydrogen atom, halogen atom, alkyl group having 1 to 10 carbon atoms, aryl group having 6 to 10 carbon atoms, cycloalkyl group or aralkyl group having 7 to 10 carbon atoms, and W is an alkylene group having 1 to 6 carbon atoms, alkylidene group having 2 to 10 carbon atoms, cycloalkylene group having 6 to 10 carbon atoms, cycloalkylidene group having 6 to 10 carbon atoms, alkylene-arylene-alkylene group having 8 to 15 carbon atoms, oxygen atom, sulfur atom, sulfoxide group, sulfone group or single bond, as a main recurring unit,

and which has (B) a viscosity-average molecular weight of 10,000 to 100,000, (C) terminal groups consisting essentially of an aryloxy group and a phenolic hydroxyl group, the molar ratio of the aryloxy group to the phenolic hydroxyl group being 97/3 to 40/60, (D) a melt viscosity stability of 0.5% or less, and (E1) a peak at 3,290±50 G in magnetic field, the (ΔI×(ΔH)²) value obtained from the height (ΔI) of this peak and a magnetic field difference (ΔH) between the bottom of the peak and the top of the peak being 500 or less.

According to the present invention, secondly, the above objects and advantages of the present invention are attained by an aromatic polycarbonate (may be referred to as “second aromatic polycarbonate” hereinafter) which has the above features (A), (B), (C) and (D) and (E2) aradical concentration of 1×10¹⁵ or less (per g.polycarbonate).

According to the present invention, thirdly, the above objects and advantages of the present invention are attained by an aromatic polycarbonate composition (may be referred to as “first composition” hereinafter) comprising:

(1) 100 parts by weight of an aromatic polycarbonate which comprises (A) a recurring unit represented by the following formula (a):

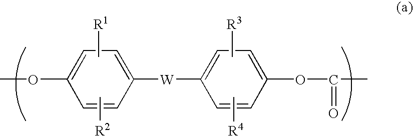

wherein R¹, R 2, R3 and R4 are each independently a hydrogen atom, halogen atom, alkyl group having 1 to 10 carbon atoms, aryl group having 6 to 10 carbon atoms, cycloalkyl group or aralkyl group having 7 to 10 carbon atoms, and W is an alkylene group having 1 to 6 carbon atoms, alkylidene group having 2 to 10 carbon atoms, cycloalkylene group having 6 to 10 carbon atoms, cycloalkylidene group having 6 to 10 carbon atoms, alkylene-arylene-alkylene group having 8 to 15 carbon atoms, oxygen atom, sulfur atom, sulfoxide group, sulfone group or single bond, as a main recurring unit,

and which has (B) a viscosity-average molecular weight of 10,000 to 100,000, (C) terminal groups consisting essentially of an aryloxy group and a phenolic hydroxyl group, the molar ratio of the arylxoy group to the phenolic hydroxyl group being 97/3 to 40/60 and (D) a melt viscosity stability of 0.5% or less, and

(2) 5×10⁻³ to 2×10⁻¹ part by weight of a partial ester of a higher fatty acid having 8 to 25 carbon atoms and a polyhydric alcohol;

and having (3)-1 a peak at3,290±50G in magnetic field, the (ΔI×(ΔH)²) value obtained from the height (ΔI) of this peak and a magnetic field difference (ΔH) between the bottom of the peak and the top of the peak being 650 or less, and (4)-1 a (ΔI×(ΔH)²) value of 800 or less after it is kept molten at 380° C. for 10 minutes.

According to the present invention, in the fourth place, the above objects and advantages of the present invention are attained by an aromatic polycarbonate composition (may be referred to as “second composition” hereinafter) having the above features (A), (B), (C), (D) and (2) and (3)-2 a radical concentration of 1×10¹⁵ or less (per g.polycarbonate) and (4)-2 a radical concentration of 2×10¹⁵ or less (per g.polycarbonate) after it is kept molten at 380° C. for 10 minutes.

Finally, according to the present invention, in the fifth place the above objects and advantages of the present invention are attained by an optical disk substrate made from either one of the above aromatic polycarbonate and the above aromatic polycarbonate composition of the present invention.

### BRIEF DESCRIPTION OF THE DRAWINGS

FIG. 1 is a diagram showing the relationship between the viscosity-average molecular weight Mw of an aromatic polycarbonate and the lowest temperature (Tc) at which fine crystalline particles are not formed.

### THE PREFERRED EMBODIMENTS OF THE INVENTION

The present invention will be described in detail hereinbelow. A description is first given of the first aromatic polycarbonate, followed by the other inventions.

The first aromatic polycarbonate of the present invention has the above characteristic feature (E1) in particular. That is, the magnetic field has a peak at 3,290±50 G and the (ΔI×(ΔH)²) value obtained from the height (ΔI) of this peak and a magnetic field difference (ΔH) between the bottom of the peak and the top of the peak is 500 or less. This value is an index for the total amount of radicals contained in the aromatic polycarbonate. The larger this value the greater the total amount of radicals becomes.

Although the reason why the total amount of radicals is related to the color and transparency of a polymer is unknown, it is assumed that active radical species detected by ESR take some part in the formation of tinting impurities in the polycarbonate. Therefore, it is presumed that the total amount of radical species is preferably as small as possible. However, when the radical species are existent to a certain extent, a preferred tendency toward the prevention of the formation of a by-product such as a gel is seen. The above value indicative of the total amount of radicals is preferably 10 to 400, particularly preferably 20 to 350.

The effective means of controlling the total amount of radicals contained in the aromatic polycarbonate of the present invention are given below.

1) In each production step of a polycarbonate, the temperature difference between the temperature of a bulk polymer and the temperature of an area whose temperature goes up to the highest in the step is reduced to 50° C. or less and the temperature of the highest temperature area is controlled to 340° C. or less to suppress the radical decomposition of polycarbonate molecules. More specifically, the rotation speed of the agitating element in a reactor is controlled, or the generation of agitation heat is controlled, and a high-pressure treatment at 0.7 to 2 MPa with an inert gas is carried out in the final stage of the reaction.

2) In the above step, a radical scavenger is preferably used. As the radical scavenger may be used a known agent disclosed in Chapter 2, pp. 41-69 of “Stabilization of Polymeric Materials” written by Hans Zweifel and published by Springer.

3) Further, after an aromatic polycarbonate is obtained, an aromatic polycarbonate polymer solution is prepared and purified by cleaning with water and re-precipitation to control the total amount of radicals and suppress the proceeding of coloring to a low level after production.

In the step of cleaning the polymer with water, the polymer solution is preferably dehydrated completely after cleaning. For dehydration, a silica gel treatment or filtration using a filter having fine pores is used. The re-precipitation of the polymer is carried out by adding a poor solvent such as methanol or acetonitrile to a methylene chloride or 1-methyl-2-pyrrolidone (to be abbreviated as NMP hereinafter) solution of the polymer. In order to obtain a polymer having higher purity, it is preferred to add the poor solvent little by little over a long time.

Preferably, the first aromatic polycarbonate of the present invention has a ((ΔI×(ΔH)²) value of 700 or less after it is kept molten at 380° C. for 10 minutes. The first aromatic polycarbonate having the above preferred property can be advantageously obtained by melt polymerizing an aromatic dihydroxy compound and a carbonic acid diester in the presence of at least one ester exchange catalyst selected from the group consisting of a lithium compound, rubidium compound and cesium compound as will be described hereinafter.

In the above formula (a) of the first aromatic polycarbonate of the present invention, R¹ and R⁴are as defined hereinabove.

Examples of the halogen atom include fluorine, chlorine and bromine.

The alkyl group having 1 to 10 carbon atoms may be linear or branched. Examples of the alkyl group having 1 to 10 carbon atoms include methyl, ethyl, propyl, butyl, octyl and decyl. Examples of the cycloalkyl group having 6 to 10 carbon atoms include cyclohexyl and 3,3,5-trimethylcyclohexyl.

Examples of the aryl group having 6 to 10 carbon atoms include phenyl, tolyl and naphthyl.

Examples of the aralkyl group having 7 to 10 carbon atoms include benzyl, phenethyl and cumyl.

W is as defined hereinabove.

The alkylene group having 1 to 6 carbon atoms may be linear or branched. Examples thereof include methylene, 1,2-ethylene, 1,3-propylene, 1,4-butylene and 1,6-hexylene.

Examples of the alkylidene group having 2 to 10 carbon atoms include ethylidene, 2,2-propylidene, 2,2-butylidene and 3,3-hexylidene.

Examples of the cycloalkylene group having 6 to 10 carbon atoms include 1,4-cyclohexylene and 2-isopropyl-1,4-cyclohexylene.

Examples of the cycloalkylidene group having 6 to 10 carbon atoms include cyclohexylidene and isopropylcyclohexylidene.

Examples of the alkylene-arylene-alkylene group having 8 to 15 carbon atoms include m-diisopropylphenylene.

In the above formula (a), preferably, W is an alkylidene group having 2 to 10 carbon atoms and R¹ to R⁴are each a hydrogen atom. W is more preferably cyclohexylidene or 2,2-propylidene, particularly preferably 2,2-propylidene.

Preferably, the aromatic polycarbonate contains the recurring unit represented by the above formula (a) in an amount of at least 85 mol % based on the total of all the recurring units.

The aromatic polycarbonate of the present invention may be produced by any conventionally known process such as melt polymerization or interfacial polymerization but it is preferably produced by melt polycondensing an aromatic dihydroxy compound and a carbonic acid diester in terms of of costs including process and raw materials and no need of using a polymerization solvent such as hydrocarbon chloride and further a harmful compound such as phosgene as a carbonate forming compound.

The melt polymerization process is carried out by heating and stirring an aromatic dihydroxy compound (to be abbreviated as ADC hereinafter) and a carbonic acid diester under a normal-pressure and/or vacuum nitrogen atmosphere and distilling out the formed alcohol or aromatic monohydroxy compound. The reaction temperature which differs according to the boiling point of the formed product or the like is generally 120 to 350° C. to remove an alcohol or aromatic monohydroxy compound formed by the reaction, preferably 180 to 280° C. to obtain an aromatic polycarbonate having a low total content of metal impurities, more preferably 250 to 270° C.

The inside pressure of the system is reduced in the latter stage of the reaction to make it easy to distill out the formed alcohol or aromatic monohydroxy compound. The inside pressure of the system in the latter stage of the reaction is preferably 133.3 Pa (1 mmHg) or less, more preferably 66.7 Pa (0.5 mmHg) or less. Additionally, in the final stage of the reaction, that is, within 20 minutes before the end of the polycondensation reaction, particularly before or after the stage including the addition of a melt viscosity stabilizer, a high-pressure treatment at 0.7 to 2 MPa with an inert gas such as nitrogen gas or carbonic acid gas is preferably carried out. The pressure of this high-pressure treatment is more preferably 1 to 2 MPa.

ADC and the carbonic acid diester used as raw materials are preferably prepared by using a known purification method such as distillation, extraction, recrystallization or sublimation, or purification operation combining these. Out of these, the raw materials are preferably purified by long-time sublimation at a temperature as low as possible, more preferably by combining sublimation with any one of the above purification methods.

To obtain an aromatic polycarbonate having a low total content of metal impurities, a high-purity solvent having an extremely low total content of metal impurities is preferably used for the purification of the raw materials and polymer. For example, a solvent for use in the electronic industry may be used.

In the present invention, an aromatic polycarbonate having excellent durability, stability and transparency when it is used under a moist heat condition which is not conceivable in the prior art for a long time can be provided by specifying the content of each specific metal element in the aromatic polycarbonate to a predetermined value or less.

Taking into consideration an influence upon the durability, color and transparency of a polycarbonate to be produced, it is recommended to reduce the total content of trace metal elements such as transition metal elements including Fe, Cr, Mn, Ni, Pb, Cu and Pd, metals including Si, Al and Ti and metalloid elements as impurities contained in the raw materials to preferably 50 ppb or less, more preferably 10 ppb or less.

To obtain an aromatic polycarbonate having higher durability, the total content of alkali metal elements and/or alkali earth metal elements having high ester exchangeability contained in ADC and the carbonic acid diester is preferably 0 to 60 ppb.

To obtain an aromatic polycarbonate having much higher durability., the total content of alkali metal elements and/or alkali earth metal elements in ADC and the carbonic acid diester is preferably 60 ppb or less and the total content of transition metal elements in ADC and the carbonic acid diester is preferably 10 ppb or less.

Further, the total content of the above metals and metalloid elements in the carbonic acid diester and ADC is preferably 20 ppb or less.

An aromatic polycarbonate having excellent durability can be obtained by preferably using ADC and a carbonic acid diester as raw materials having as low a total content of the transition metal elements, metals or metalloid elements as possible, for example, 10 ppb or less which is the limit of the prior art.

ADC used in the present invention is represented by the following formula (b):

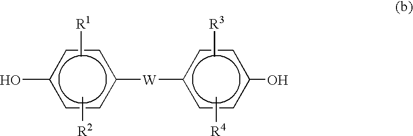

wherein R¹, R², R³, R⁴ and W are as defined in the above formula (1).

Examples of ADC include

2,2-bis(4-hydroxyphenyl)propane (so-called bisphenol A),

1,1-bis(2-hydroxyphenyl)methane,

1,1-bis (4 -hydroxyphenyl ) methane,

1,1-bis(4-hydroxyphenyl)ethane,

1,1-bis(4-hydroxyphenyl)-1-phenylethane,

1,1-bis(4-hydroxyphenyl)propane,

2,2-bis(2-hydroxyphenyl)propane,

2,2-bis(4-hydroxy-3,5-dimethylphenyl)propane,

2,2-bis(4-hydroxy-3,5-dibromophenyl)propane,

2,2-bis(4-hydroxy-3-methylphenyl)propane,

2,2-bis(4-hydroxyphenyl)pentane,

3,3-bis(4-hydroxyphenyl)pentane,

1,1-bis(4-hydroxyphenyl)cyclohexane,

1,1-bis(4-hydroxyphenyl)-3,3,5-trimethylcyclohexane,

2,2,2′,2′-tetrahydro-3,3,3′,3′-tetramethyl-1,1′-spirobis [1H-indene]-6,6-diol, bis(4-hydroxyphenyl)sulfide,

bis(4-hydroxyphenyl)sulfone and what have an alkyl group or aryl group substituted in the aromatic ring according to the above definition. Dihydroxybenzene derivatives such as hydroquinone, 2-t-butylhydroquinone, resorcinol and 4-cumylresorcinol may also be used. They may be used alone or in combination of two or more. Out of these, bisphenol A is particularly preferred from an economical point of view.

Examples of the carbonic acid diester include diphenyl carbonate (to be abbreviated as DPC hereinafter), dinaphthyl carbonate, bis(diphenyl)carbonate, dimethyl carbonate, diethyl carbonate and dibutyl carbonate. Out of these, DPC is preferred from an economical point of view.

In the present invention, as the ester exchange catalyst are preferably used (i) at least one compound selected from the group consisting of a nitrogen-containing basic compound and a phosphorus-containing basic compound (to be abbreviated as NCBA hereinafter) and (ii) at least one compound selected from the group consisting of an alkali metal compound and an alkali earth metal compound (to be abbreviated as AMC hereinafter).

Examples of the nitrogen-containing basic compound as NCBA include ammonium hydroxides having an alkyl, aryl or alkylaryl group such as tetramethylammonium hydroxide (Me₄NOH) and benzyltrimethylammonium hydroxide (φ—CH₂(Me)₃NOH); basic ammonium salts having an alkyl, aryl or alkylaryl group such as tetramethylammonium acetate, tetraethylammoniumphenoxide, tetrabutylammoniumcarbonates and benzyltrimethylammonium benzoates; tertiary amines such as triethylamine and dimethylbenzylamine; and basic salts such as tetramethylammonium borohydride (Me₄NBH₄), tetrabutylammonium borohydride (Bu₄NBH₄) and tetramethylammonium tetraphenylborate (Me₄NBPh₄).

Examples of the phosphorus-containing basic compound as NCBA include phosphonium hydroxides having an alkyl, aryl or alkylaryl group such as tetrabutylphosphonium hydroxide (BU₄POH) and benzyltrimethylphosphonium hydroxide (φ—CH₂(Me)₃POH); and basic salts such as tetramethylphosphonium borohydride (Me₄PBH₄), tetrabutylphosphonium borohydride (Bu₄PBH₄) and tetramethylphosphonium tetraphenylborate (Me₄PBPh₄).

The above NCBA is used in an amount of 10 to 1,000 μ chemical equivalents in terms of basic nitrogen atom or basic phosphorus atom based on 1 mol of ADC. The amount of NCBA is more preferably 20 to 500 μ chemical equivalents, particularly preferably 50 to 500 μ chemical equivalents based on the same standard.

It is assumed that the color of the polycarbonate is worsened by interaction between iron contained in the carbonic acid diester and aromatic dihydroxy compound as the raw materials and the above nitrogen-containing basic compound and/or phosphorus-containing basic compound. It is preferred to reduce the total content of metal impurities as much as possible in this sense.

Further, in the present invention, an alkali metal and/or alkali earth metal compound (AMC) are/is used in conjunction with NCBA to reflect the effect of reducing impurities contained in the raw materials on the color and stability of the polymer. A compound containing an alkali metal is preferably used as AMC. The alkali metal compound is used in an amount of 0.01 to 5 μ chemical equivalents in terms of alkali metal element based on 1 mol of ADC. By using the catalyst in the above ratio, undesired phenomena such as a branching reaction and main-chain cleavage reaction which readily occur during the polycondensation reaction, and the formation of foreign matter and yellowing in the apparatus during molding can be suppressed effectively without impairing the terminal capping reaction rate and the polycondensation reaction rate to be maintained, which is preferred for the object of the present invention.

When the amount is outside the above range, the catalyst may exert a bad influence upon the physical properties of the obtained polycarbonate, or an ester exchange reaction may not proceed fully, thereby making it impossible to obtain a polycarbonate having a high molecular weight.

AMC used as the catalyst is a hydroxide, hydrocarbon compound, carbonate, carboxylate such as acetate, stearate orbenzoate, nitrate, nitrite, sulfite, cyanate, thiocyanate, borohydride, hydrogenphosphate, bisphenol or phenol salt of an alkali metal.

Specific examples of AMC include sodium hydroxide, potassium bicarbonate, sodium carbonate, potassium carbonate, cesium carbonate, lithium acetate, rubidium nitrate, lithium nitrate, sodium nitrite, sodium sulfite, sodium cyanate, potassium cyanate, sodium thiocyanate, potassium thiocyanate, cesium thiocyanate, sodium stearate, sodium borohydride, potassium borohydride, lithium borohydride, sodium tetraphenyl borate, sodium benzoate, disodium hydrogenphosphate, dipotassium hydrogenphosphate, disodium salts, monopotassium salts and sodium potassium salts of bisphenol A and potassium salts of phenol.

The ate-complex alkali metal salt (a) of the group XIV element of the periodic table or the alkali metal salt (b) of the oxo acid of the group XIV element of the periodic table disclosed by JP-A 7-268091 may be used as the alkali metal compound used as a catalyst as desired in the present invention. The group XIV element of the periodic table is silicon, germanium or tin.

By using the above alkali metal compound as a polycondensation reaction catalyst, a polycondensation reaction can proceed quickly and completely. In addition, the alkali metal compound can control an undesired side reaction such as a branching reaction which proceeds during the polycondensation reaction to a low level.

In the polycondensation reaction of the present invention, at least one compound selected from the group consisting of oxo acids and oxides of the group XIV elements of the periodic table and alkoxides and phenoxides of the same elements may be optionally existent as a co-catalyst together with the above catalyst. By using the co-catalyst in a predetermined proportion, undesired phenomena such as a branching reaction and main-chain cleavage reaction which readily occur during the polycondensation reaction, and the formation of foreign matter and yellowing in the apparatus during molding can be suppressed effectively without impairing the terminal capping reaction rate and the polycondensation reaction rate, which is preferred for the object of the present invention.

The oxo acids of the group XIV elements of the periodic table include silicic acid, stannic acid and germanic acid.

The oxides of the group XIV elements of the periodic table include silicon dioxide, tin dioxide, germanium dioxide, silicon tetramethoxide, silicon tetraphenoxide, tetraethoxytin, tetranonyloxytin, tetraphenoxytin, tetrabutoxygermanium, tetraphenoxygermanium and condensates thereof.

Preferably, the co-catalyst is existent in such a proportion that the amount of the group XIV element of the periodic table becomes 50 molar atoms or less based on 1 molar atom of an alkali metal element contained in the polycondensation reaction catalyst. When the co-catalyst is used in such a proportion that the amount of the metal element becomes more than 50 molar atoms, the polycondensation reaction rate slows down disadvantageously.

More preferably, the co-catalyst is existent in such a proportion that the amount of the group XIV element of the periodic table becomes 0.1 to 30 molar atoms based on 1 molar atom of the alkali metal element contained in the polycondensation reaction catalyst.

Since a sodium compound has a greater influence upon the durability of the produced aromatic polycarbonate than alkali metals other than sodium, a lithium compound, rubidium compound or cesium compound is preferably used as a catalyst in the present invention to obtain an aromatic polycarbonate having excellent durability.

The amount of the polymerization catalyst in the present invention is 0.05 to 5 μ chemical equivalents, preferably 0.07 to 3 μ chemical equivalents, particularly preferably 0.07 to 2 μ chemical equivalents based on 1 mol of ADC when an alkali metal compound and an alkali earth metal compound are used.

The melt polymerization process is carried out by heating and stirring the above aromatic dihydroxy compound and carbonic acid diester in the presence of the above ester exchange catalyst under a normal-pressure and/or vacuum nitrogen atmosphere and distilling out the formed alcohol or aromatic monohydroxy compound. The reaction temperature which differs according to the boiling point of the formed product or the like is generally 120 to 350° C. to remove an alcohol or aromatic monohydroxy compound formed by the reaction. It is preferred that the temperature of the polymer should be reduced to a low level in order to suppress the generation of heat by shearing and the ultimate temperature to a level as low as possible. However, when the temperature of the polymer is set to a low level during polymerization, fine crystalline particles may be formed in the polycarbonate. If the fine crystalline particles are formed in large quantities, the mechanical strength of the obtained molded article may lower. Further, if the polycarbonate fine crystalline particles are existent in the polycarbonate melting, the shearing function will be more strengthened, thereby producing radical species mechanochemically. Therefore, it is preferred to suppress the content of the fine crystalline particles in the polycarbonate. Accordingly, it is important that the temperature of the reaction mixture should not fall below the lowest temperature (Tc) shown in the attached graph at which the fine crystalline particles are not formed from the time when the molecular weight of the reaction mixture exceeds 7,000.

The number of the fine crystalline particles having a melting point of 310° C. or more can be greatly reduced by maintaining the temperature of a low-temperature portion within the reactor at a temperature higher than the minimum temperature determined by the average molecular weight of the reaction mixture.

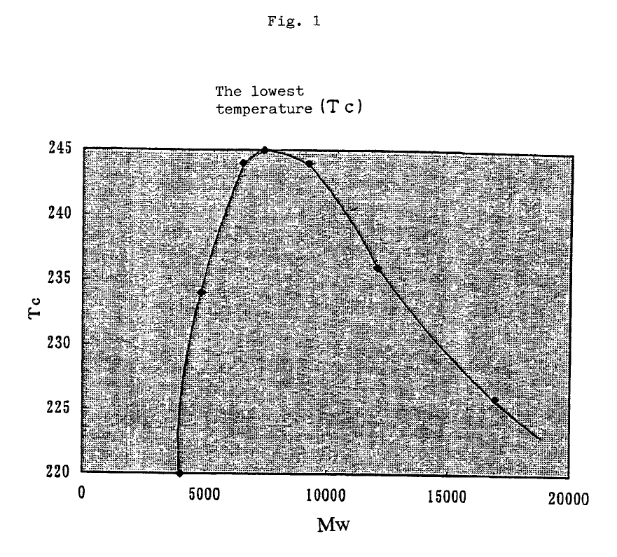

When the viscosity-average molecular weight of the reaction mixture is represented by Mw and the above minimum temperature is represented by Tc, a curve shown in the attached graph (FIG. 1) for smoothly connecting points (Tc, Mw)=(220, 4,000), (234,4,810), (244,6,510), (245,7,400), (244,9,210), (236, 12,050) and (226, 17,000) is obtained in a region where Mw is 3,000 to 18,000 of a graph where Tc (° C) is plotted on the axis of ordinate and Mw is plotted on the axis of abscissa.

To reduce the content of the fine crystalline particles, it is important that the temperature (Tc) of the low-temperature portion within the reaction system during polymerization should not fall within a region surrounded by the above curve and the axis of abscissa and it is particularly preferred that the lowest temperature at a polymerization degree ranging from a low to a medium level should be kept at a temperature above the curve of this region.

The upper limit of the temperature during polymerization may be suitably selected from the ordinary temperature range of polymerization. When the polymerization temperature is too high, the molar balance may be lost by the volatilization of a monomer and an oligomer in the region of a low polymerization degree, and a side-reaction becomes marked at a high polymerization degree. Therefore, the upper limit temperature is 270° C. when Mw<6,000, 310° C. when 6,000 ≦Mw<10,000 and 330° C. when Mw>10,000.

The inside pressure of the system is reduced in the latter stage of the reaction to make it easy to distill out the formed alcohol or aromatic monohydroxy compound. The inside pressure of the system in the latter stage of the reaction is preferably 133.3 Pa (1 mmHg) or less, more preferably 66.7 Pa (0.5 mmHg) or less. Additionally, in the final stage of the reaction, that is, within 20 minutes before the end of the polycondensation reaction, particularly before or after the stage including the addition of a melt viscosity stabilizer, a high-pressure treatment at 0.7 to 2 MPa with an inert gas such as nitrogen gas or carbonic acid gas is preferably carried out to control the total amount of radicals though the reason for this is unknown. The pressure of this high-pressure treatment is more preferably 1 to 2 MPa.

The aromatic polycarbonate of the present invention has a melt viscosity stability of 0.5% or less. The melt viscosity stability is evaluated based on the absolute value of a change in melt viscosity measured under a nitrogen air stream at a shear rate of 1 rad/sec and a temperature of 300° C. for 30 minutes and expressed by change rate per minute. This value should be reduced to 0.5% or less. When this value is large, the deterioration by hydrolysis, reduction in molecular weight or coloring of the aromatic polycarbonate may be promoted. In order to ensure practical stability against hydrolysis, a value of 0.5% suffices. To this end, the melt viscosity is preferably stabilized by using a melt viscosity stabilizer after polymerization.

The melt viscosity stabilizer in the present invention also has the function of deactivating part or all of the activity of a polymerization catalyst used for the production of the aromatic polycarbonate.

To add the melt viscosity stabilizer, for example, it may be added while the polymer is molten after polymerization or after the aromatic polycarbonate is pelletized and re-molten. In the former case, the melt viscosity stabilizer may be added while the aromatic polycarbonate which is the reaction product in the reactor or extruder is molten, or may be added and kneaded before the aromatic polycarbonate obtained after polymerization is pelletized from the reactor through the extruder.

Any known melt viscosity stabilizer may be used. From the viewpoint of the large effect of improving the physical properties such as color, heat resistance and boiling water resistance of the obtained polymer, sulfonic acid compounds such as organic sulfonic acid salts, organic sulfonates, organic sulfonic anhydrides and organic sulfonic acid betaines may be used, out of which phosphonium salts of sulfonic acid and/or ammonium salts of sulfonic acid are preferred. Out of these, dodecylbenzenesulfonic acid tetrabutyl phosphonium salts and paratoluenesulfonic acid tetrabutyl ammonium salts are particularly preferred.

The aromatic polycarbonate of the present invention has a viscosity-average molecular weight of 10,000 to 100,000. The aromatic polycarbonate used to form an injection molded article, for example, a disk substrate has a viscosity-average molecular weight (Mw) of preferably 10,000 to 22,000, more preferably 12,000 to 20,000, particularly preferably 13,000 to 18,000. The polycarbonate having the above viscosity-average molecular weight has sufficiently high strength as an optical material and excellent melt fluidity at the time of molding and is free from molding strain. The aromatic polycarbonate used to form an extrusion molded article, for example, a sheet has a viscosity-average molecular weight of preferably 17,000 to 100,000, more preferably 20,000 to 80,000.

The aromatic polycarbonate of the present invention has terminal groups substantially consisting of an aryloxy group (A) and a phenolic hydroxyl group (B), and the molar ratio (A)/(B) is 97/3 to 40/60. The concentration of the phenolic terminal group is preferably 40 mol % or less, more preferably 30mol % or less. When the phenolic terminal group is contained in that above ratio, the object of the present invention can be more advantageously attained and the moldability of the composition (mold staining properties, releasability; to be simply referred to as “moldability” hereinafter) is also improved.

The further improvement of the physical properties of the composition is rarely effected by reducing the concentration of the phenolic terminal group to less than 3 mol %. When the phenolic terminal group is introduced in an amount of more than 60 mol %, it is not preferred for the object of the present invention as obvious from the above description.

The aryloxy group is preferably a nonsubstituted phenyloxy group or a phenyloxy group substituted by a hydrocarbon group having 1 to 20 carbon atoms. From the viewpoint of resin heat stability, a phenyloxy group having a tertiary alkyl group, tertiary aralkyl group or aryl group as a substituent, or nonsubstituted phenyloxy group is preferred. What has benzyl-type hydrogen atoms may be used for a desired object such as the improvement of resistance to activation radiation but it is recommended not to use it from the viewpoint of stability against heat, heat deterioration and heat decomposition.

Preferred examples of the aryloxy group include phenoxy group, 4-t-butylphenyloxy group, 4-t-amylphenyloxy group, 4-phenylphenyloxy group and 4-cumylphenyloxy group.

In the interfacial polymerization process, the concentration of the phenolic hydroxyl group can be reduced to a low level by means of a molecular weight control agent. However, in the melt polymerization process, there are methods that the concentration of the phenolic hydroxyl group is reduced positively because an aromatic polycarbonate containing a phenolic hydroxyl group in an amount of 60 mol % or more is readily produced through a chemical stoichiometry.

That is, the following method 1) or 2) can be advantageously used to adjust the concentration of the phenolic terminal group to the above range:

1) method of controlling the molar ratio of charge stocks; The molar ratio of the carbonic acid diester to the aromatic dihydroxy compound is increased at the time of charging for a polymerization reaction. For example, in consideration of the characteristic features of a polymerization reactor, it is increased to a range of 1.03 to 1.10.

2) terminal capping method; At the end of a polymerization reaction, terminal phenolic hydroxyl groups are capped by adding a salicylate-based compound described in U.S. Pat. No. 5,696,222 in accordance with the method disclosed by the above document.

When the salicylate-based compound is used to cap the terminal hydroxyl groups, the amount of the salicylate-based compound is preferably 0.8 to 10 mols, more preferably 0.8 to 5 mols, particularly preferably 0.9 to 2 mols based on 1 chemical equivalent of the terminal phenolic hydroxyl group before a capping reaction. By adding the salicylate-based compound in the above ratio, 80% or more of the terminal phenolic hydroxyl groups can be capped advantageously. To carry out this capping reaction, catalysts disclosed by the above US patent are preferably used.

The concentration of the phenolic terminal group is preferably reduced before the deactivation of the polymerization catalyst.

Salicylate-based compounds enumerated in the specification of U.S. Pat No. 5,696,222 may be preferably used as the salicylate-based compound, as exemplified by

2-methoxycarbonylphenylaryl carbonates such as

2-methoxycarbonylphenyl-phenyl carbonate;

2-methoxycarbonylphenyl-alkyl carbonates such as

2-methoxycarbonylphenyl-lauryl carbonate;

2-ethoxycarbonylphenyl-aryl carbonates such as

2-ethoxycarbonylpheny-phenyl carbonate;

2-ethoxycarbonylphenyl-alkyl carbonates such as

2-ethoxycarbonylphenyl-octyl carbonate;

(2′-methoxycarbonylphenyl)esters of aromatic carboxylic acids such as (2-methoxycarbonylphenyl)benzoate; and

aliphatic carboxylates such as (2-methoxycarbonylphenyl)stearate and

bis(2-methoxycarbonylphenyl)adipate.

A description is subsequently given of the second aromatic polycarbonate of the present invention.

In the second aromatic polycarbonate, the total amount of radicals is directly specified by the following index (E2) unlike the first aromatic polycarbonate in which the total amount of radicals is specified by the above index (E1).

The concentration of radicals (E2) is 1×10¹⁵ or less (per g polycarbonate).

The index (E1) overlaps with the index (E2) but does not perfectly agree with the index (E2).

The concentration of radicals of the second aromatic polycarbonate is preferably 1×10¹² to 6×10¹⁴ (per g.polycarbonate). It is more preferably 2×10¹⁵ or less (per g polycarbonate) after it is kept molten at 380° C. for 10 minutes. The radicals may cause an undesired reaction such as coloring or branching but seem to have the function of preventing the chain proceeding of a reaction. Therefore, it is assumed that the existence of a certain amount of radicals is preferred.

The second aromatic polycarbonate is preferably obtained by melt polymerizing an aromatic dihydroxy compound and a carbonic acid diester in the presence of an ester exchange catalyst like the first aromatic polycarbonate.

Melt polymerization is carried out in the presence of at least one ester exchange catalyst selected preferably from the group consisting of a lithium compound, rubidium compound and cesium compound, more preferably from the group consisting of a rubidium compound and cesium compound.

As for what is not described herein of the second aromatic polycarbonate of the present invention, it should be understood that the above description of the first aromatic polycarbonate is directly applied to the second aromatic polycarbonate.

A description is subsequently given of the first composition of the present invention.

The first composition contains an aromatic polycarbonate specified by the same requirements as the above requirements (A), (B), (C) and (D) specifying the first aromatic polycarbonate.

This aromatic polycarbonate is obtained by melt polycondensing an aromatic dihydroxy compound and a carbonic acid diester in the presence of at least one ester exchange catalyst selected preferably from the group consisting of a lithium compound, rubidium compound and cesium compound, more preferably from the group consisting of a rubidium compound and cesium compound. It is particularly preferably the above first aromatic polycarbonate having the above property (E1) and obtained as described above.

This first composition contains a partial ester of a higher fatty acid having 8 to 25 carbon atoms and a polyhydric alcohol in addition to the above aromatic polycarbonate. The higher fatty acid having 8 to 25 carbon atoms may be either saturated or unsaturated, preferably a mono/- or poly-carboxylic acid having a functionality of 2 or more. The polyhydric alcohol maybe either saturated or unsaturated.

Examples of the saturated or unsaturated higher fatty acid having 8 to 25 carbon atoms include arachidonic acid, behenic acid, docosahexaenoic acid, decanoic acid, dodecanoic acid, eicosapentaenoic acid, stearic acid, caproic acid, oleic acid, lignoceric acid, cerotic acid, melissic acid and tetratriacontanoic acid.

Examples of the polyhydric alcohol include saturated and unsaturated dihydric alcohols such as ethylene glycol, propylene glycol, 1,4-butanediol, 1,4-butenediol, neopentylene glycol and diethylene glycol; saturated and unsaturated trihydric alcohols such as glycerin and trimethylolpropane; and saturated and unsaturated alcohols having a functionality of 4 or more such as pentaerythritol and dipentaerythritol.

Examples of the partial ester of a polyhydric alcohol and a higher fatty acid include pentaerythritol monostearate, pentaerythritol distearate, pentaerythritol tristearate, pentaerythritol monooleate, pentaerythritol dioleate, pentaerythritol trioleate, pentaerythritol monobehenate, pentaerythritol dibehenate, pentaerythritol tribehenate, glycerol monobehenate, glycerol dibehenate, glycerol monolaurate, glycerol dilaurate, glycerol monostearate, glycerol distearate, trimethylolpropane monooleate and trimethylolpropane distearate.

The amount of the partial ester of a higher fatty acid having 8 to 25 carbon atoms and a polyhydric alcohol is 5×10⁻³ to 2×10⁻¹ part by weight, preferably 10⁻¹ part by weight based on 100 parts by weigh of the polycarbonate resin.

The first composition has a magnetic field peak at 3,290±50 G, a ((ΔI×(ΔH)²) value obtained from the height (ΔI) of this peak and a magnetic field difference (ΔH) between the bottom of the peak and the top of the peak of 650 or less, preferably 30 to 500, particularly preferably 50 to 400, and a ((ΔI×(ΔH)²) value of 800 or less after it is kept molten at 380° C. for 10 minutes.

The first composition may optionally contain a complete ester of a conventionally known aliphatic carboxylic acid (including an alicyclic carboxylic acid) and a monohydric or polyhydric alcohol in limits not prejudicial to the object of the present invention, in addition to the above partial ester of a polyhydric alcohol and a higher fatty acid.

Examples of the aliphatic carboxylic acid include arachidonic acid, behenic acid, docosahexaenoic acid, decanoic acid, dodecanoic acid, eicosapentaenoic acid, stearic acid, caproic acid, oleic acid, lignoceric acid, cerotic acid, melissic acid and tetratriacontanoic acid.

Examples of the monohydric or polyhydric alcohol include saturated and unsaturated monohydric alcohols such as 2-ethylhexylalcohol, decylalcohol, stearyl alcohol and oleyl alcohol; saturated and unsaturated dihydric alcohols such as ethylene glycol, propylene glycol, 1,4-butanediol, 1,4-butenediol, neopentylene glycol and diethylene glycol; saturated and unsaturated trihydric alcohols such as glycerin and trimethylolpropane; and saturated and unsaturated alcohols having a functionality of 4 or more such as pentaerythritol and dipentaerythritol.

Examples of the complete ester include stearyl stearate, pentaerythritol tetrastearate, glycerol tribehenate, glycerol trilaurate, glycerol tristearate, trimethylolpropane trioleate and trimethylolpropane tristearate.

A release agent whose examples are given below may be optionally used:

1) hydrocarbon-based release agents such as natural and synthetic paraffin waxes, polyethylene wax and fluorocarbons, 2) fatty acid-based release agents such as higher fatty acids including stearic acid and hydroxy fatty acids including hydroxystearic acid, 3) fatty acid amide-based release agents such as fatty acid amides including ethylene bisstearylamide and alkylenebis fatty acid amides including erucic acid amide, 4) alcohol-based release agents such as aliphatic monoalcohols including stearyl alcohol and cetyl alcohol and polyhydric alcohols including polyglycols and polyglycerols, and 5) polysiloxanes.

The amount of the optional release agent is preferably 0.0001 to 0.1 part by weight based on 100 parts by weight of the aromatic polycarbonate resin.

The above release agents may be used alone or in admixture of two or more.

The first composition may contain a bluing agent, particularly an organic bluing agent to improve the organoleptically favorable impression of a molded article. Although the bluing agent tends to change its color considerably at the time of heat melt molding, a specific phosphoric acid acidic phosphonium salt listed below is used in the composition to obtain a large stabilization effect.

Examples of the bluing agent include Solvent Violet 13 (CA. NO (color index number) 60725; Microlex Violet B of Bayer AG, Dia Resin Blue G of Mitsubishi Chemical Co., Ltd. and Sumiplast Violet B of Sumitomo Chemical Co., Ltd.), Solvent Violet 31 (CA. No.68210; Dia Resin Violet D of Mitsubishi Chemical Co., Ltd.), Solvent Violet 33 (CA. No.60725; Dia Resin Blue J of Mitsubishi Chemical Co., Ltd.), Solvent Blue 94 (CA. No.61500; Dia Resin Blue N of Mitsubishi Chemical Co., Ltd.), Solvent Violet 36 (CA. No.68210; Microlex Violet 3R of Bayer AG), Solvent Blue 97 (Microlex Blue RR of Bayer AG), and Solvent Blue 45 (CA. No.61110; Tetrazole Blue RLS of Sand AG), Microlex Violet and Triazole Blue RLS of Ciba Specialty Chemicals, AG. Out of these, Microlex Violet and Triazole Blue RLS are preferred.

These bluing agents may be used alone or in combination. The amount of the bluing agent is preferably 1×10⁻⁷ to 1×10⁻² part by weight, more preferably 0.01×10⁻⁴ to 10×10⁻⁴ part by weight, much more preferably 0.05×10⁻⁴ to 5×10⁻⁴ part by weight, particularly preferably 0.1×10⁻⁴ to 3×10⁻⁴ part by weight based on 100 parts by weight of the aromatic polycarbonate.

The first composition of the present invention preferably contains a specific phosphoric acid acidic phosphonium salt. The specific phosphoric acid acidic phosphonium salt is at least one selected from phosphonium salts having specific structures represented by the following formulas (c)-1 to (c)-3:

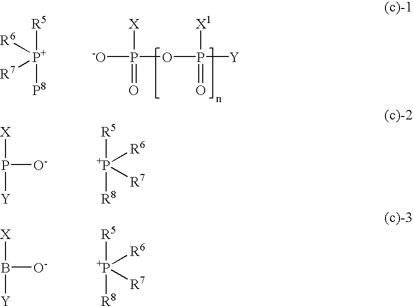

wherein R⁵ to R⁸ are each independently a hydrocarbon group having 1 to 10 carbon atoms, X and Y are each independently a hydroxy group, quaternary phosphonium group represented by the following formula (d):

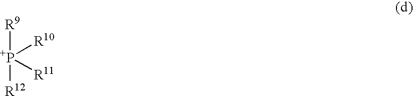

(wherein R⁹ to R¹² are the same as R⁵ to R⁸) alkoxy group having 1 to 20 carbon atoms, cycloalkoxy group, aryloxy group, aralkyloxy group, alkyl group having 1 to 20 carbon atoms, cycloalkyl group, aryl group or aralkyl group, at least one of X, X¹ and Y is a hydroxy group, and X and Y may form a ring through an oxygen atom, and n is 0 or a positive integer.

The amount of the phosphoric acid acidic phosphonium salt is preferably 1×10⁻⁶ to 1 part by weight, more preferably 1×10⁻⁶ to 3×10⁻² part by weight (0.01 to 300 ppm), much more preferably 5×10⁻⁶to 2×10⁻² part by weight, particularly preferably 1×10⁻⁵ to 1×10⁻² part by weight based on 100 parts by weight of the aromatic polycarbonate. Further, the amount of a phosphorus component contained in the specific phosphoric acid acidic phosphonium salt is preferably 0.001×10⁻⁴ to 30×10⁻⁴ part by weight, more preferably 0.005×10⁻⁴ to 20×10⁻⁴ part by weight, particularly preferably 0.01×10⁻⁴ to 10×10⁻⁴ part by weight in terms of phosphorus atom based on 100 parts by weight of the aromatic polycarbonate from a viewpoint of the amount of phosphorus.

When the amount of the above agent is smaller than the above lower limit, desired stability is hardly obtained and when the amount is larger than the above upper limit, heat resistance, particularly heat resistance during molding is liable to degrade.

Examples of compounds from the specific phosphoric acid acidic phosphonium salt include phosphoric acid hydrogen diphosphonium salts, phosphoric acid dihydrogen phosphonium salts, phosphonic acid hydrogen phosphonium salts, phosphorous acid hydrogen diphosphonium salts, phosphorous acid dihydrogen phosphonium salts, phosphonous acid hydrogen phosphonium salts, boric acid hydrogen diphosphonium salts, boric acid dihydrogen phosphonium salts and condensation phosphoric acid acidic phosphonium salts.

Specific examples of the above compounds are given below. phosphoric acid diphosphonium salts:

bis(tetramethylphosphonium)hydrogenphosphate, bis(tetrabutylphosphonium)hydrogenphosphate, bis(tetraphenylphosphonium)hydrogenphosphate, bis[tetrakis(2,4-di-t-butylphenyl)phosphonium]hydrogenphosphate, bis(tetrabenzylphosphonium)hydrogenphosphate and bis(trimethylbenzylphosphonium)hydrogenphosphate phosphoric acid dihydrogen phosphonium salts:

tetramethylphosphonium dihydrogenphosphate, tetrabutylphosphonium dihydrogenphosphate, tetrahexadecylphosphonium dihydrogenphosphate, tetrabenzylphosphonium dihydrogenphosphate, trimethylbenzylphosphonium dihydrogenphosphate and dimethyldibenzylphosphonium dihydrogenphosphate phosphonic acid hydrogen phosphonium salts:

(tetrabutylphosphonium)hydrogen benzenephosphonate, (tetrabutylphosphonium)hydrogen benzylphosphonate, acidic tetramethylphosphonium hydrogen octanephosphonate, tetrabutylphosphonium hydrogen methanephosphonate and tetraphenylphosphonium hydrogen benzenephosphonate phosphorous acid hydrogen diphosphonium salts:

bis(tetramethylphosphonium)hydrogen phosphite, bis(tetrabutylphosphonium)hydrogen phosphite, bis[tetrakis(2,4-di-t-butylphenyl)phosphonium]hydrogen phosphite and bis(trimethylbenzylphosphonium)hydrogen phosphite phosphorous acid dihydrogen phosphonium salts:

tetramethylphosphonium dihydrogenphosphite, tetrabutylphosphonium dihydrogenphosphite, tetrahexadecylphosphonium dihydrogenphosphite, tetraphenylphosphonium dihydrogenphosphite, trimethylbenzylphosphonium dihydrogenphosphite and dimethyldibenzylphosphonium dihydrogenphosphite phosphonous acid hydrogen phosphonium salts:

(tetrabutylphosphonium)hydrogen benzenephosphonite, tetramethylphosphonium hydrogen octanephosphonite, tetraethylphosphonium hydrogen toluenephosphonite, tetrabutylphosphonium hydrogen methanephosphonite and tetramethylphosphonium hydrogen hexanephosphonite boric acid hydrogen disphosphonium salts:

bis(tetrabenzylphosphonium)hydrogenborate, bis(trimethylbenzylphosphonium)hydrogenborate, bis(dibutyldihexadecylphosphonium)hydrogenborate and (tetradecylphosphonium)(tetramethylphosphonium) hydrogenborate boric acid dihydrogen phosphonium salts:

tetramethylphosphonium dihydrogenborate, tetrabutylphosphonium dihydrogenborate, tetraphenylphosphonium dihydrogenborate and trimethylbenzylphosphonium dihydrogenborate condensation phosphoric acid acidic phosphonium salts:

tetrabutylphosphonium trihydrogen pyrophosphate

Out of these specific phosphoric acid acidic phosphonium salts, particularly preferred are

bis(tetramethylphosphonium)hydrogenphosphate,

bis(tetrabutylphosphonium)hydrogenphosphate,

tetramethylphosphonium dihydrogenphosphate,

tetrabutylphosphonium dihydrogenphosphate,

bis(tetramethylphosphonium)hydrogenphosphite,

bis(tetrabutylphosphonium)hydrogenphosphite,

tetramethylphosphonium dihydrogenphosphite,

tetrabutylphosphonium dihydrogenphosphite,

bis(tetramethylphosphonium)hydrogenborate and

tetramethylphosphonium dihydrogenborate.

Further, a sulfuric acid or sulfurous acid acidic phosphonium salt whose examples are given below may be optionally used in the present invention.

Examples of the sulfuric acid acidic phosphonium salt include tetramethylphosphonium hydrogensulfate, tetrabutylphosphonium hydrogensulfate, tetraphenylphosphonium hydrogensulfate and trimethyloctylphosphonium hydrogensulfate. Examples of the sulfurous acid acidic phosphonium salt include tetramethylphosphonium hydrogensulfite, tetraphenylphosphonium hydrogensulfite and benzyltrimethylphosphonium hydrogensulfite.

The first composition of the present invention may contain a conventionally known processing stabilizer, heat stabilizer, antioxidant, ultraviolet light absorber, antistatic agent and flame retardant according to application purpose, when molded articles are formed therefrom.

Out of these, the heat stabilizer is phosphorous acid, phosphoric acid, phosphonous acid, phosphonic acid or ester thereof, steric hindered phenol or steric hindered amine. Specific examples of the heat stabilizer include

trisnonylphenyl phosphite,

tris(2,4-di-tert-butylphenyl)phosphite,

tetrakis(2,4-di-tert-butylphenyl) 4,4′-biphenylenediphosphinate, trimethyl phosphate,

dimethyl benzenephosphonate,

5,7-di-t-butyl-3-(3,4-dimethylphenyl)-3H-benzofuran-2-one,

n-octadecyl-3-(3,5-di-t-butyl-4-hydroxyphenyl)propionate and 2-t-butyl-6-(3-t-butyl-2-hydroxy-5-methylbenzyl)-4-methylphenyl-acrylate. These heat stabilizers may be used alone or in admixture of two or more. The amount of the heat stabilizer is preferably 0.0001 to 1 part by weight, more preferably 0.0005 to 0.5 part by weight, particularly preferably 0.001 to 0.1 part by weight based on 100 parts by weight of the aromatic polycarbonate.

The aromatic polycarbonate of the present invention may further contain a solid filler such as an inorganic or organic filler in limits not prejudicial to the object of the present invention to improve stiffness. Examples of the solid filler include lamellar or granular inorganic fillers such as talc, mica, glass flake, glass bead, calcium carbonate and titanium oxide, fibrous fillers such as glass fiber, glass milled fiber, wollastonite, carbon fiber, aramide fiber and metal-based conductive fiber, and organic particles such as crosslinked acrylic particle and crosslinked silicone particle. The amount of the solid filler is preferably 1 to 150 parts by weight, more preferably 3 to 100 parts by weight based on 100 parts by weight of the aromatic polycarbonate.

The inorganic filler usable in the present invention may be surface treated with a silane coupling agent. A favorable effect such as the suppression of the decomposition of the aromatic polycarbonate is obtained from this surface treatment.

The first composition of the present invention may further contain another resin different from the aromatic polycarbonate of the first composition in limits not prejudicial to the object of the present invention, that is, 10 to 150 parts by weight based on 100 parts by weight of the aromatic polycarbonate of the first composition.

Examples of the another resin include a polyamide resin, polyimide resin, polyether imide resin, polyurethane resin, polyphenylene ether resin, polyphenylene sulfide resin, polysulfone resin, polyolef in resin such as polyethylene or polypropylene, polyester resin, non-crystalline polyarylate resin, polystyrene resin, polymethacrylate resin, phenol resin and epoxy resin.

The above polyester resin is a polymer or copolymer obtained by a condensation reaction and comprising an aromatic dicarboxylic acid or reactive derivative thereof and a diol or ester derivative there of as main components. Specifically, preferred examples of the polyester resin include polyethylene terephthalate (PET), polypropylene terephthalate (PPT), polybutylene terephthalate (PBT), polyethylene 2,6-naphthalate (PEN), polybutylene 2,6-naphthalate (PBN), copolyesters such as polyethylene isophthalate/terephthalate and polybutylene terephthalate/isophthalate, and mixtures thereof.

The amount of the polyester resin is not particularly limited but preferably such that the weight ratio of the aromatic polycarbonate to the polyester resin is 40/60 to 91/9, preferably 50/50 to 90/10. When the amount of the aromatic polycarbonate is smaller than 40 wt %, the impact resistance becomes unsatisfactory and when the amount is larger than 91 wt %, the chemical resistance becomes unsatisfactory disadvantageously. To make the effective use of the characteristic properties of the aromatic polycarbonate resin, the amount of the polyester resin is preferably 50 wt % or less, more preferably 40 wt % or less, particularly preferably 30 wt % or less.

The above polystyrene resin is a polymer obtained by polymerizing a styrene monomer and optionally at least one selected from another vinyl monomer and a rubber-like polymer copolymerizable with the styrene monomer.

Examples of the styrene monomer include styrene, α-methylstyrene and p-methylstyrene.

Examples of the another vinyl monomer include vinyl cyanide compounds such as acrylonitrile, (meth)acrylates such as methyl acrylate, maleimide-based monomers, α,β-unsaturated carboxylic acids and anhydrides thereof.

Examples of the rubber-like polymer include polybutadiene, polyisoprene, styrene butadiene copolymer and acrylonitrile-butadiene copolymer.

The polystyrene-based resin is exemplified by conventionally known styrene-based resins out of which polystyrene (PS), impact resistant polystyrene (HIPS), acrylonitrile.styrene copolymer (AS resin), methyl methacrylate/butadiene/styrene copolymer (MBS resin), acrylonitrile/butadiene/styrene copolymer (ABS resin) and styrene/IPN type rubber copolymer and mixtures thereof are preferred and ABS resins is the most preferred. The polystyrene-based resins may be used in admixture of two or more.

The amount of the polystyrene-based resin is not particularly limited but preferably such that the weight ratio of the aromatic polycarbonate to the polystyrene-based resin is 40/60 to 91/9, preferably 50/50 to 90/10. When the amount of the aromatic polycarbonate is smaller than 40 wt %, the impact resistance becomes unsatisfactory and when the amount is larger than 91 wt %, the moldability becomes unsatisfactory disadvantageously. To make the effective use of the characteristic properties of the aromatic polycarbonate, the polystyrene resin is used in an amount of 50 wt % or less, preferably 40 wt % or less.

A rubber-like elastic material may be added to the aromatic polycarbonate of the present invention to improve impact resistance. The rubber-like elastic material is a graft copolymer obtained by copolymerizing at least one monomer selected from the group consisting of aromatic vinyls such as styrene, vinyl cyanide, (meth) acrylates such as methyl methacrylate and vinyl compounds copolymerizable therewith with a rubber component having a glass transition temperature of 10° C. or less unlike the above polystyrene-based resin. A thermoplastic elastomer which has no crosslinking structure such as a polyurethane elastomer, polyester elastomer or polyether amide elastomer may also be used.

A rubber-like elastic material comprising butadiene rubber, butadiene-acrylic composite rubber, acrylic rubber or acrylic-silicon composite rubber as the rubber component having a glass transition temperature of 10° C. or less is preferred.

The rubber-like elastic material can be easily acquired from the market. Commercially available products of the rubber-like elastic material which comprises butadiene rubber or butadiene-acrylic composite rubber as the main rubber component having a glass transition temperature of 10° C. or less include Kaneace B series of Kanegafuchi Chemical Industry Co., Ltd., Metabrene C series of Mitsubishi Rayon Co., Ltd., and EXL series, HIA series, BTA series and KCA series of Kureha Chemical Industry Co., Ltd. Commercially available products of the rubber-like elastic material which comprises acrylic-silicon composite rubber as the main rubber component having a glass transition temperature of 10° C. or less include Metabrene S-2001 and RK-200 of Mitsubishi Rayon Co., Ltd.

The amount of the rubber-like elastic material is preferably 3 to 40 parts by weight based on 100 parts by weight of the aromatic polycarbonate.

To mix the above components with the polycarbonate of the present invention, any means is employed. For example, a tumbler, twin-cylinder mixer, super mixer, Nauter mixer, Banbury mixer, kneading roll or extruder is advantageously used. A sheet can be obtained by melt extrusion or a molded article having excellent durability and stability can be obtained by injection molding from the thus obtained aromatic polycarbonate composition (first composition) directly or after it is pelletized by a melt extruder.

A description is subsequently given of the second composition of the present invention.

The second composition of the present invention differs from the first composition in that the total amount of radicals is directly specified as follows in place of the above index for the total amount of radicals in the first composition. That is, the concentration of radicals is 1×10¹⁵ or less (per g.polycarbonate), preferably 1×10¹² to 1×10¹⁵ (per g.polycarbonate) and 2×10¹⁵ or less (per g.polycarbonate) after the composition is kept molten at 380° C. for 10 minutes.

The aromatic polycarbonate used in the second composition of the present invention is preferably an aromatic polycarbonate obtained by melt polymerizing an aromatic dihydroxy compound and a carbonic acid diester in the presence of at least one ester exchange catalyst selected from the group consisting of a lithium compound, rubidium compound and cesium compound, particularly preferably the above second aromatic polycarbonate having the above property (E2) obtained as described above.

The second composition preferably contains a bluing agent in an amount of 1×10⁻⁷ to 1×10⁻² part by weight like the first composition. The second composition preferably contains a solid filler in an amount of 1 to 150 parts by weight from another point of view and further a thermoplastic resin different from the aromatic polycarbonate of the second composition in an amount of 10 to 150 parts by weight from still another point of view.

The aromatic polycarbonate and aromatic polycarbonate composition of the present invention can retain the color and durability of the polymer, especially durability under extreme temperature and humidity conditions for a long time, by reducing the total amount of radicals to a predetermined value or less as described above. Substrates, made from the polymer, for high-density optical disks typified by CD, CD-ROM, CD-R, CD-RW, magnetic optical disks (MO) and digital versatile disks (such as DVD-ROM, DVD-Video, DVD-Audio, DVD-R and DVD-RAM) can obtain high reliability for a long time. The aromatic polycarbonate and aromatic polycarbonate composition of the present invention are particularly useful for substrates for high-density optical disks such as digital versatile disks.

The reasons why the aromatic polycarbonate and aromatic polycarbonate composition of the present invention are useful for these optical disk substrates are that the total amount ((ΔI)×(ΔH)²) of radicals contained in an optical disk substrate made from the aromatic polycarbonate of the present invention is reduced to 500 or less and the concentration of radicals is reduced to 1×10¹⁵ or less (per g) and also that the total amount ((ΔI)×(ΔH)²) of radicals contained in an optical disk substrate made from the aromatic polycarbonate composition of the present invention can be reduced to 650 or less and the concentration of radicals can be reduced to 1×10¹⁵ or less (per g).

Sheets made from the aromatic polycarbonate and aromatic polycarbonate composition of the present invention are excellent in adhesion and printability and widely used in electric parts, building material parts and auto parts thanks to the above characteristic properties. More specifically, they are useful for optical application such as various window materials, that is, grazing products for window materials for general houses, gyms, baseball domes and vehicles (such as construction machinery, automobiles, buses, bullet trains and electric vehicles), various side wall panels (such as sky domes, top lights, arcades, wainscots for condominiums and side panels on roads), window materials for vehicles, displays and touch panels for OA equipment, membrane switches, photo covers, polycarbonate resin laminate panels for water tanks, front panels and Fresnel lenses for projection TVs and plasma displays, optical cards, optical disks, liquid crystal cells consisting of a polarizer, and phase difference compensators. The thickness of the sheet is generally 0.1 to 10 mm, preferably 0.2 to 8 mm, particularly preferably 0.2 to 3 mm. Various treatments for providing new functions (such as a laminate treatment for improving weatherability, a treatment for improving scratch resistance for improving surface hardness, surface drawing and processing for making translucent or opaque) may be carried out on the sheet.

Molded articles having excellent durability and stability can be obtained from the aromatic polycarbonate and aromatic polycarbonate composition of the present invention by extrusion molding and injection molding.

The aromatic polycarbonate and aromatic polycarbonate composition of the present invention may be used for any purpose and can be used in electronic and communication equipment, OA equipment, optical parts such as lenses, prisms, optical disk substrates and optical fibers, electronic and electric materials such as home electric appliances, lighting members and heavy electric members, mechanical materials such as car interiors and exteriors, precision machinery and insulating materials, miscellaneous materials such as medical materials, safety and protective materials, sports and leisure outfits and home supplies, container and package materials, display and decoration materials. They may also be advantageously used as a composite material with another resin, or organic or inorganic material.

### EXAMPLES

### Analysis

1) Intrinsic Viscosity of Polycarbonate [η];

This was measured in methylene chloride at 20° C. with an Ubbellohde viscometer. The viscosity-average molecular weight (Mw) was calculated from the intrinsic viscosity based on the following equation.

[η]=1.23×10⁻⁴×Mw^{0.83}

2) Concentration of Terminal Group;

0.02 g of a sample was dissolved in 0.4 ml of chloroform deuteride and the number of terminal phenolic hydroxyl groups and the concentration of phenolic terminal groups were measured at 20° C. using ¹H-NMR (EX-270 of JEOL Ltd.).

The number of aryloxy groups was obtained from a difference between the total number of terminal groups obtained based on the following equation and the number of phenolic hydroxyl groups. total number of terminal groups=56.54/[η]^{1.4338}

3) Melt Viscosity Stability;

The absolute value of a change in melt viscosity measured at a shear rate of 1 rad/sec and a temperature of 300° C. under a nitrogen air stream using the RAA type fluidity analyzer of Rheometrics Co., Ltd. was measured for 30 minutes to obtain a change rate per minute.

This value does not exceed 0.5% when the aromatic polycarbonate and the aromatic polycarbonate composition of the present invention have satisfactory short-term and long-term stabilities. When this value exceeds 0.5%, the hydrolysis stability of the composition becomes poor. This value is used to evaluate hydrolysis stability.

4) Measurement of Radical Parameters;

4)-1 Measurement of Total Amount of Radicals;

About 350 mg of aromatic polycarbonate chips was weighed and placed in an ESR sample tube to measure a peak at a region of 3,270 to 3,310G under the following conditions using the following device, and ΔI (=peak top value−peak bottom value) and ΔH (=magnetic field at peak bottom−magnetic field at peak top) were read when a length (3 cm) equal to three divisions of the scale of the original chart was 100 to obtain the total amount of radicals ((ΔI×ΔH²). This value was judged as a parameter related to the total amount of radicals contained in the actualpolymer and taken as “the total amount of radicals” in the present invention.

device; ESR JES FE-2XC of JEOL LTD.
measurement conditions;

| | |
|---|---|
| magnetic field range | 32.90 ± 5.0 mT |
| modulation | 100 kHz 0.20 mT |
| microwave output | 5 mW |
| amplitude | 5 × 1000 |
| response | 3 sec |
| sweep time | 16 min |

4)-2 Concentration of Radicals

The concentration of radicals was measured under the following conditions using the following measuring instrument at room temperature by cutting out an about 3 mm×17 mm×2 mm measurement sample from an aromatic polycarbonate sample.

device; ESP350E of Bruker Co., Ltd.

| accessories | |
|---|---|
| microwave frequency counter | HP5351B (of Hewlett Packeard |
| | Co., Ltd.) |
| gauss meter | ER035 (of Bruker Co., Ltd.) |
| cryostat | ESR910 (of Oxford Co., Ltd.) |
| measurement conditions; | |
| magnetic field range | 331.7 to 341.7 mT |
| modulation | 100 kHz 0.5 mT |
| microwave output | 9.44 GHz, 1.0 mW |
| sweep time | 83.886 s × 16 times |
| time constant | 327.68 ms |
| number of data points | 1,048 |
| cavity | TM₁₁₀ cylindrical |

5) Durability of Rromatic Polycarbonate (Moist Heat Durability);

To test the long-term durability of the aromatic polycarbonate under extreme temperature and humidity conditions, 10 samples were prepared for each polymer which was kept at 85° C. and 90 RH % for 1,000 hours to carry out the following measurements.

5) Deterioration of Color;

The color of a polymer pellet was measured using the Z-1001DP color difference meter of Nippon Denshoku Co., Ltd. The L and b values of the 10 samples were obtained to calculate the mean values thereof.

As the greater the L value, the higher the brightness becomes and the smaller the b value, the less the yellowing becomes. And it is preferable the higher is the brightness and the less the yellowing.

When the deterioration of the b value after the durability test, that is, the difference in Δb (b value after durability test−b value before durability test) and the scatter of b values, that is, Δb (Max−Min) (difference between the maximum value and the minimum value of Δb in 10 samples) in the table is 0 to 1, it was evaluated that the samples had desired color stability even when they were used under extreme temperature and humidity conditions for a long time.

5)-2 Transparency;

A color sample plate measuring 50×50×2 mm was molded at a cylinder temperature of 280° C. and a mold cycle of 3.5 sec using the Neomat N150/75 of Sumitomo Heavy Industries, Ltd. to measure the total light transmittance of the plate with the NDH-Σ80 of Nippon Denshoku Co., Ltd. The higher the total light transmittance the higher the transparency becomes. When the total light transmittance was 90% or more after the durability test, it was evaluated that the sample retained desired transparency even after long-time use under extreme temperature and humidity conditions.

5)-3 Moist Heat Stability of Impact Resistance;

This was evaluated based on Izod impact strength in accordance with ASTM D256 (notched). The polycarbonate was dried under high vacuum for 12 hours, and a 3.2 mm injection molded test piece was formed with a mold. This was used to obtain Izod impact strength retention after deterioration by moist heat.

When the retention was 90% or more, it was evaluated that the test piece retained desired strength even after long-time use under extreme temperature and humidity conditions.

6) Preparation of Composition Pellet and Evaluation of Molding of a Disk Substrate;

The aromatic polycarbonate after melt polymerization was transferred by a gear pump and additives shown in Table 2-2 were added right before a vented twin-screw extruder [KTX-46 of Kobe Steel Co., Ltd.] and melt kneaded at a cylinder temperature of 240° C. under deaeration to produce a pellet. The pellet was used to produce a DVD (DVD-Video) disk substrate so as to make a moist heat deterioration test on the disk substrate.

Molding Conditions of Disk Substrate

A mold exclusive for DVD was set in an injection molding machine (DISK3 MIII of Sumitomo Heavy Industries, Ltd.), a nickel DVD stamper which stored information such as an address signal was set in this mold, the above pellet was supplied into the hopper of the molding machine automatically, and a DVD disk substrate having a diameter of 120 mm and a thickness of 0.6 mm was molded at a cylinder temperature of 380° C., a mold temperature of 115° C., an injection rate of 200 mm/sec and a holding pressure of 3,432 kPa (35 kgf/cm²).

7) Evaluation of Residence Yellowing;

The residence yellowing was measured as a parameter for coloring stability during molding.

Evaluation of Residence Yellowing

The color (color: L, a, b) of a 50×50×2 mm color sample plate molded at a cylinder temperature of 380° C. and a mold temperature of 80° C. with the Neomat N150/75 injection molding machine of Sumitomo Heavy Industries, Ltd. and the color (color: L′, a′, b′) of a color sample plate obtained by causing the resin to stay in the cylinder at 380° C. for 10 minutes before molding and molding were measured with the Z-1001DP color difference meter of Nippon Denshoku Co., Ltd. to evaluate residence yellowing based on ΔE represented by the following equation.

ΔE=[(L−L′)²+(a−a′)²+(b−b′)²]^{1/2}

The ΔE value is related to the size of a molecular weight reduction and greatly affects the organoleptic test of the molded article.

Since the color of a molded article greatly worsens and there is a fair possibility that a molded article having a strong yellow tint is obtained in the case of an aromatic polycarbonate when the ΔE value is larger than 3, it is judged as defective. It is judged as accepted when the value is 2.5 to 3.0, satisfactory when the value is 2.0 or more and less than 2.5, and excellent when the value is less than 2. The smaller the value the more excellent the article becomes. It is needless to say that a value of 1.9 is better than a value of 2.0.

### Raw Material Purification Examples

1) Bisphenol A (May be Abbreviated as BPA Hereinafter)

Commercially available bisphenol A was dissolved in phenol in a ratio of 1/5 to prepare an adduct crystal of bisphenol A and phenol at 40° C., and the phenol was removed from the obtained adduct crystal at 5.3 kPa (40 Torr) and 180° C. until the concentration of the phenol in bisphenol A became 3% and further by steam stripping. Thereafter, the above bisphenol A was charged into a vessel equipped with a decompressor and cooler and purified by sublimation at a pressure of 13.3 Pa (0.1 Torr) and a temperature of 139° C. under a nitrogen atmosphere. The sublimation purification was repeated twice to obtain purified bisphenol A.

2) Diphenyl Carbonate (May be Abbreviated as DPC Hereinafter)

Purified diphenyl carbonate was obtained by cleaning raw material diphenyl carbonate with hot water (50° C.) three times, drying and carrying out vacuum distillation in accordance with the method described at page 45 of “Plastic Material Lecture 17 Polycarbonate” written by Toshihisa Tachikawa and published by Nikkan Kogyo Shimbun Co., Ltd. to sample a fraction at 167 to 168° C. and 2.000 kPa (15 mmHg) and further carrying out sublimation purification in the same manner as described above.

The contents of metal impurities in the raw materials and purified products are shown in Table 1 below.

TABLE 1

| | | metal impurities (ppb) | | | | | | | | | | | | |
|---|---|---|---|---|---|---|---|---|---|---|---|---|---|---|
| | | Na | Fe | Cr | Mn | Ni | Pb | Cu | Zn | Pd | In | Si | Al | Ti |
| type of BPA | commercially | 86 | 60 | 5 | 4 | 8 | 5 | 1* | 11 | 1* | 7 | 25 | 22 | 1* |
| | available BPA | | | | | | | | | | | | | |
| | purified BPA | 6 | 8 | 1* | 1* | 1* | 1* | 1* | 1* | 1* | 1* | 1 | 1 | 1* |
| type of DPC | raw material DPC | 96 | 40 | 15 | 5 | 5 | 1 | 1* | 11 | 1* | 15 | 15 | 42 | 3 |
| | purified DPC | 10 | 9 | 1* | 1* | 1* | 1* | 1* | 1* | 1* | 1* | 1* | 1 | 1* |

1*: 1 ppb or less

### Example 1

An aromatic polycarbonate was produced as follows.

137 parts by weight of the purified BPA and 133 parts by weight of the purified DPC as raw materials, and 4.1×10⁻⁵ part by weight of bisphenol A disodium salt (may be abbreviated as BPANa2 salt hereinafter) and 5.5×10⁻³ part by weight of tetramethylammonium hydroxide (maybe abbreviated as TMAH hereinafter) as polymerization catalysts were charged into a reactor equipped with a stirrer, distillation column, decompressor and pressure device and molten at 180° C. under a nitrogen atmosphere.

Under stirring at a revolution speed of 40 rpm, the inside pressure of the reactor was reduced to 13.33 kPa (100 mmHg) and a reaction was carried out for 20 minutes while the formed phenol was distilled off.

By gradually reducing the pressure after the temperature was raised to 200° C., the reaction was further continued at 4.000 kPa (30 mmHg) for 20 minutes while the phenol was distilled off. By gradually increasing the temperature, the reaction was further carried out at 220° C. for 20 minutes, 240° C. for 20 minutes and 260° C. for 20 minutes and then the pressure was gradually reduced to carry out the reaction at 2.666 kPa (20 mmHg) for 10 minutes and 1.333 kPa (10 mmHg) for 5 minutes under stirring at a revolution speed of 30 rpm at 270° C. The revolution speed was changed to 20 rpm when the viscosity-average molecular weight became 10,000 according to the relationship between rotation power and viscosity-average molecular weight so as to maintain the temperature of a shearing portion between the agitating element and the reactor whose temperature rose to the highest in the polymerization reactor at 320° C. or less. The reaction was finally carried out at 270° C. and 66.7 Pa (0.5 mmHg) until the viscosity-average molecular weight became 15,300. Thereafter, the pressure reduction was slowed down, the pressure was increased to 15 MPa (15 atm) with nitrogen gas, and 3.6×10⁻⁴ part by weight of tetrabutylphosphonium dodecylbenzenesulfonate was added and stirred at 260° C. for 10 minutes. Pressurization was released, and the resulting product was transferred by a gear pump and pelletized.

The finally obtained polycarbonate had a viscosity-average molecular weight of 15,300, a phenolic terminal group concentration of 87 (eq/ton.poylcarbonate), a phenoxy terminal group concentration of 152 (eq/ton.polycarbonate) and a melt viscosity stability of 0%.

### Comparative Example 1

137 parts by weight of the purified BPA and 133 parts by weight of the purified DPC as raw materials, and 4.1×10⁻⁵ part by weight of bisphenol A disodium salt and 5.5×10⁻³ part by weight of tetramethylammonium hydroxide as polymerization catalysts were charged into a reactor equipped with a stirrer, distillation column and decompressor and molten at 180° C. under a nitrogen atmosphere.

Under stirring at a revolution speed of 40 rpm, the inside pressure of the reactor was reduced to 13.33 kPa (100 mmHg) and a reaction was carried out for 20 minutes while the formed phenol was distilled off. By gradually reducing the pressure after the temperature was raised to 200° C., the reaction was further continued at 4.000 kPa (30 mmHg) for 20 minutes while the phenol was distilled off.

By gradually increasing the temperature, the reaction was further carried out at 220° C. for 20 minutes, 240° C. for 20 minutes and 260° C. for 20 minutes and then the pressure was gradually reduced to carry out the reaction at 2.666 kPa (20 mmHg) for 10 minutes and 1.333 kPa (10 mmHg) for 5 minutes under stirring at a revolution speed of 40 rpm at 270° C. Stirring was still continued at 40 rpm even when the viscosity-average molecular weight became 10,000 according to the relationship between rotation power and viscosity-average molecular weight. Although the temperature of a shearing portion between the agitating element and the reactor whose temperature rose to the highest in the polymerization reactor went up to 340° C., the reaction was continued in that state and finally at 270° C. and 66.7 Pa (0.5 mmHg) until the viscosity-average molecular weight became 15,300. Thereafter, 3.6×10⁻⁴ part by weight of tetrabutylphosphonium dodecylbenzenesulfonate was added without carrying out pressurization operation and kneaded at 270° C. and 66.7 Pa (0.5 mmHg) for 10 minutes.

The obtained product was pelletized with the same operation as in Example 1. The finally obtained polycarbonate had a viscosity-average molecular weight of 15,300, a phenolic terminal group concentration of 85 (eq/ton.polycarbonate), a phenoxy terminal group concentration of 154 (eq/ton.polycarbonate) and a melt viscosity stability of 0%.

### Example 2

0.05 part by weight of the Sumirizer SM of Sumitomo Chemical Company, Limited was added as a scavenger when the stirring speed was changed to 30 rpm at 270° C. in Example 1, and the pressure was gradually reduced under stirring to carry out a reaction at 2.666 kPa (20 mmHg) for 10 minutes and 1.333 KPa (10 mmHg) for 5 minutes. The revolution speed was changed to 20 rpm when the viscosity-average molecular weight became 8,000 according to the relationship between rotation power and viscosity-average molecular weight so as to maintain the temperature of a shearing portion between the agitation element and the reactor whose temperature rose to the highest in the polymerization reactor at 320° C. or less. The reaction was finally carried out at 270° C. and 66.7 Pa (0.5 mmHg) until the viscosity-average molecular weight became 15,300. Thereafter, the pressure reduction was slowed down, the pressure was increased to 1.5 MPa (15 atm) with nitrogen gas, and 3.6×10⁻⁴ part by weight of tetrabutylphosphonium dodecylbenzenesulfonate was added and stirred at 260° C. for 10 minutes. Pelletization was carried out with the same operation as in Example 1.

The finally obtained polycarbonate had a viscosity-average molecular weight of 15,300, a phenolic terminal group concentration of 85 (eq/ton.poylcarbonate), a phenoxy terminal group concentration of 154 (eq/ton.polycarbonate) and a melt viscosity stability of 0%.

### Example 3

The aromatic polycarbonate obtained in Example 1 was dissolved in 1.5×10³ parts by weight of high-purity N-methylpyrrolidone (may be abbreviated as NMP hereinafter) for use in the electronic industry, 1.1×10⁴ parts by weight of high-purity methanol for use in the electronic industry was gradually added to the resulting solution, and the precipitated polymer was separated by filtration and washed with 1 equivalent of methanol twice. The solvent was removed from the obtained product at 13.3 Pa (0.1 mmHg) and 100° C. and the resulting product was dried.

The obtained polycarbonate had a viscosity-average molecular weight of 15,300, a phenolic terminal group concentration of 84 (eq/ton.poylcarbonate), a phenoxy terminal group concentration of 155 (eq/ton.poylcarbonate) and a melt viscosity stability of 0%.

### Examples 4 and 5

3.1×10⁻⁵ part by weight of rubidium hydroxide and 4.5×10⁻⁵ part by weight of cesium hydroxide were used in place of 4.1×10⁻⁵ part by weight of bisphenol A disodium salt in Example 1 to carry out polymerization. 3.6×10⁻⁴ part by weight of tetrabutylphosphonium dodecylbenzenesulfonate was added and the resulting product was pelletized with the same operation as in Example 1.

The obtained polycarbonate of Example 4 had a viscosity-average molecular weight of 15,300, a phenolic terminal group concentration of 84 (eq/ton.poylcarbonate), a phenoxy terminal group concentration of 155 (eq/ton.polycarbonate) and a melt viscosity stability of 0%. The obtained polycarbonate of Example 5 had a viscosity-average molecular weight of 15,300, a phenolic terminal group concentration of 82 (eq/ton.poylcarbonate), a phenoxy terminal group concentration of 157 (eq/ton.polycarbonate) and a melt viscosity stability of 0%.

### Examples 6 and 7 and Comparative Example 2

Polymerization was continued until the viscosity-average molecular weight became 22,500 in Examples 1 and 2 and Comparative Example 1 and 2.1 parts by weight of 2-methoxycarbonylphenyl-phenyl carbonate (to be abbreviated as SAM hereinafter) was added as a terminal capping agent when the viscosity-average molecular weight became 22,500 and stirred at 265° C. and 66.7 Pa (0.5 mmHg) for 10 minutes. After the pressure reduction was slowed down and the pressure was increased to 1.5 MPa (15 atm) with nitrogen gas in Examples 6 and 7 whereas pressurization operation with nitrogen gas was not carried out in Comparative Example 2, 3.6×10⁻⁴ part by weight of tetrabutylphosphonium dodecylbenzenesulfonate was added and stirred at 260° C. for 10minutes. The resulting products were transferred by a gear pump and pelletized.

The finally obtained polycarbonates had viscosity-average molecular weights of 22,500, phenolic terminal group concentrations of 30, 28 and 29 (eq/ton.polycarbonate), phenoxy terminal group concentrations of 120, 122 and 121 (eq/ton.poylcarbonate) and melt viscosity stabilities of 0%.

The evaluation results of the aromatic polycarbonates obtained from the above processes in Examples 1 to 7 and Comparative Examples 1 and 2 are shown in Table 2 below.

TABLE 2

| | initial physical properties | | | | | | |
|---|---|---|---|---|---|---|---|
| | | phenolic terminal | | total | concentration | color | |
| experimental | viscosity-average | group concentration | magnetic | amount of | of radicals | L | b |
| example | molecular weight | (mol %) | field peak G | radicals | (unit; 10¹²perg-PC) | value | value |
| C.Ex.1 | 15300 | 36 | 3280 | 520 | 1200 | 63 | 1.2 |
| Ex.1 | 15300 | 36 | 3285 | 160 | 450 | 65 | 0.3 |
| Ex.2 | 15300 | 36 | 3290 | 80 | 200 | 65 | 0 |
| Ex.3 | 15300 | 35 | 3280 | 20 | 100 | 65 | 0.2 |
| Ex.4 | 15300 | 35 | 3275 | 130 | 350 | 66 | 0.1 |
| Ex.5 | 15300 | 32 | 3280 | 120 | 320 | 66 | 0.1 |
| C.Ex.2 | 22500 | 20 | 3285 | 560 | 1700 | 62 | 2.5 |
| Ex.6 | 22500 | 19 | 3290 | 170 | 520 | 64 | 1 |
| Ex.7 | 22500 | 19 | 3275 | 130 | 400 | 64 | 0.8 |

| | physical properties after durability test | | | | | |
|---|---|---|---|---|---|---|
| | total | concentration | | | total | impact strength |
| experimental | amount of | of radicals | color deterioration | | transmittance | retention |
| example | radicals | (unit: 10¹²perg-PC) | Δb value | Δb (Max-Min) | (%) | (%) |
| C.Ex.1 | 800 | 3000 | 0.9 | 1.3 | 90 | 92 |
| Ex.1 | 250 | 700 | 0.7 | 0.8 | 91 | 92 |
| Ex.2 | 190 | 300 | 0.6 | 0.5 | 91 | 92 |
| Ex.3 | 90 | 150 | 0.6 | 0.6 | 91 | 92 |
| Ex.4 | 220 | 500 | 0.5 | 0.5 | 91 | 92 |
| Ex.5 | 210 | 600 | 0.5 | 0.5 | 91 | 92 |
| C.Ex.2 | 900 | 3500 | 0.9 | 1.3 | 90 | 95 |
| Ex.6 | 300 | 800 | 0.7 | 0.8 | 92 | 97 |
| Ex.7 | 230 | 600 | 0.6 | 0.5 | 91 | 96 |

Ex.: Example
C.Ex.: Comparative Example

### Examples 8 and 9 and Comparative Example 3

0.01 wt % of tris(2,4-di-tert-butylphenyl)phosphite and 0.08 wt % of glycerol monostearate were added to the aromatic polycarbonates of the above Examples 1 and 2 and Comparative Example 1.

The obtained compositions were melt kneaded with a vented twin-screw extruder [KTX-46 of Kobe Steel Co., Ltd.] at a cylinder temperature of 240° C. under deaeration to produce pellets. The physical properties of the pellets are shown in Table 3. DVD (DVD-Video) disk substrates were produced from the pellets and subjected to a moist heat deterioration test.

Moist Heat Deterioration Test on Disk Substrates

To test the long-term reliability of an optical disk under extreme temperature and humidity conditions, the aromatic polycarbonate optical disk substrate was kept at a temperature of 80° C. and a relative humidity of 85% for 1,000 hours and evaluated by the following measurement. number of white points: The optical disk substrate after a moist heat deterioration test was observed through a polarization microscope to count the number of white points of 20 μm or more in size. This was made on 25 optical disks to obtain the mean value of the measurement data as the number of white points.

As a result, the total amounts of radicals, the concentrations of radicals and the numbers of white points of Examples 8 and 9 and Comparative Example 3 were 250, 8×10¹⁴ per g.polycarbonate and 0.2 per substrate, 300, 6.5×K 10¹⁴ per g.polycarbonate and 0.1 per substrate, and 800, 2.2×10¹⁵ per g.polycarbonate and 2.5 per substrate, respectively.

### Examples 10 to 15 and Comparative Example 4

The aromatic polycarbonates obtained in the above Example 1 and Comparative Example 1 were directly transferred to a vented double-screw extruder [KTX-46 of Kobe Steel Co., Ltd.] by a gear pump, and additives shown in Table 3 were added based on 100 parts by weight of the polycarbonate at a cylinder temperature of 240° C. and melt kneaded under deaeration to produce pellets. The aromatic polycarbonate of Example 1 was used in Examples 10 to 15 and the aromatic polycarbonate of Comparative Example 1 was used in Comparative Example 4. The initial physical properties and physical properties after a residence yellowing test and moist heat durability test of the obtained polycarbonate pellets are shown in Table 3.

A) partial ester of higher fatty acid and polyhydric alcohol;

| | | | |
|---|---|---|---|
| A1: | glycerol monostearate, | A2: | glycerol monolaurate |
| A3: | glycerol monopalmitate, | A4: | propylene glycol monostearate |

| | |
|---|---|
| A5: | pentaerythritol monostearate |
| A6: | pentaerythritol dilaurate |

B) radical scavenger

| | |
|---|---|
| B1: | Sumirizer GM, B2 Sumirizer GS (Sumitomo Chemical Company, |
| | Limited.) |
| B3: | Irganox HP 2215 (Ciba Specialty Chemical Co., Ltd.) |

C) specific phosphoric acid acidic phosphonium compound;

| | |
|---|---|
| C1: | tetrabutylphosphonium dihydrogen phosphate |
| C2: | bis (tetramethylphosphonium) monohydrogen phosphate |
| C3: | tetramethylphosphonium dihydrogen phosphite |
| C4: | tetrabutylphosphonium monohydrogen benzenephosphonate |

D) bluing agent;

| | |
|---|---|
| D1: | Plast Violet 8840 (Arimoto Kagaku Co., Ltd.) |

### Example 16 and Comparative Example 5

The above additives shown in Table 3 were added to the polycarbonates obtained in Example 4 and Comparative Example 2 and melt kneaded under deaeration to produce pellets in the same manner as in Example 8 and Comparative Example 3. The initial physical properties and physical properties after a residence yellowing test and moist heat durability test of the obtained polycarbonate pellets were shown in Table 3.

TABLE 3

| | | composition | | | | initial physical properties | | | | |
|---|---|---|---|---|---|---|---|---|---|---|
| | viscosity- | partial | radical | specific acidic | bluing | (pellet values) | | | | |
| | average | ester | scavenger | phosphonium salt | agent | magnetic | total | concentration | color | |
| experimental | molecular | type | type | type | type | field peak | amount of | of radials | L | b |
| example | weight | (ppm) | (ppm) | (ppm) | (ppm) | G | radicals | × 10¹² per g | value | value |
| C.Ex.3 | 15300 | A1(500) | — | — | — | 3280 | 660 | 2100 | 63 | 1.2 |
| Ex.8 | 15300 | A1(500) | — | C1(5) | — | 3285 | 210 | 600 | 65 | 0.3 |
| Ex.9 | 15300 | A2(300) | — | C2(10) | — | 3290 | 220 | 630 | 65 | 0.3 |
| Ex.10 | 15300 | A3(600) | — | C3(15) | — | 3280 | 220 | 620 | 65 | 0.3 |
| Ex.11 | 15300 | A4(900) | B1(5) | C1(10) | — | 3275 | 145 | 400 | 65 | 0.2 |
| Ex.12 | 15300 | A5(500) | B2(10) | C2(10) | — | 3280 | 130 | 320 | 65 | 0.2 |
| Ex.13 | 15300 | A6(400) | B3(50) | C4(20) | — | 3285 | 120 | 250 | 65 | 0.2 |
| C.Ex.4 | 22500 | A1(1000) | — | — | — | 3290 | 670 | 2000 | 62 | 1.6 |
| Ex.14 | 22500 | A1(1000) | B2(10) | C2(10) | — | 3275 | 275 | 780 | 64 | 1 |
| Ex.15 | 22500 | A1(1000) | B3(50) | C4(20) | — | 3290 | 230 | 650 | 64 | 1 |
| C.Ex.5 | 22500 | A1(1000) | — | — | D1(0.8) | 3280 | 680 | 2100 | 64 | −2.5 |
| Ex.16 | 22500 | A1(1000) | B3(50) | C4(20) | D1(0.8) | 3275 | 180 | 620 | 64 | −2.5 |

| | residence yellowing test at 380° C. | | | physical properties after moist heat durability | | | |
|---|---|---|---|---|---|---|---|
| | for 10 minutes | | | test | | | |
| | total | concentration | residence | color stability of | | impact strength | transparency |
| experimental | amount of | of radicals | yellowing | pellet | | retention | retention |
| example | radicals | × 10¹² per g | ΔE | Δb | Δb (Max-Min) | (%) | (%) |
| C.Ex.3 | 830 | 2500 | 6 | 0.9 | 1.3 | OK | OK |
| Ex.8 | 310 | 910 | 2.5 | 0.7 | 0.8 | OK | OK |
| Ex.9 | 330 | 820 | 2.1 | 0.6 | 0.9 | OK | OK |
| Ex.10 | 290 | 870 | 2.2 | 0.6 | 0.7 | OK | OK |
| Ex.11 | 220 | 610 | 2.1 | 0.6 | 0.4 | OK | OK |
| Ex.12 | 200 | 540 | 1.9 | 0.5 | 0.4 | OK | OK |
| Ex.13 | 180 | 430 | 1.8 | 0.5 | 0.4 | OK | OK |
| C.Ex.4 | 870 | 2700 | 6.5 | 1.5 | 1.3 | OK | OK |
| Ex.14 | 460 | 1100 | 2.6 | 0.7 | 0.8 | OK | OK |
| Ex.15 | 520 | 1300 | 2.6 | 0.6 | 0.5 | OK | OK |
| C.Ex.5 | 810 | 2300 | 5.2 | 2.3 | 1.7 | OK | OK |
| Ex.16 | 350 | 890 | 1.5 | 0.8 | 0.7 | OK | OK |

Ex.: Example
C.Ex.: Comparative Example

### Names and Abbreviations of Agents

partial ester of polyhydric alcohol and fatty acid

A1: glycerol monostearate

A2: glycerol monolaurate

A3: glycerol monopalmitate

A4: propylene glycol monostearate

A5: pentaerythritol monostearate

A6: pentaerythritol dilaurate radical scavenger

B1: Sumirizer GM

B2: Sumirizer GS

B3: IRGANOX HP 2215 acidic phosphonium salt

C1: tetrabutylphosphonium dihydrogen phosphate

C2: bis(tetramethylphosphonium)monohydrogen phosphate

C3: tetramethylphosphonium dihydrogen phosphite

C4: tetrabutylphosphonium monohydrogen benzenephosphonate bluing agent

D1: Plast Violet 8840 of Arimoto Kagaku Co., Ltd.

### Sheet Evaluation Examples

### Example 17

The aromatic polycarbonate pellet of the above Example 4 was molten and quantitatively supplied to the T die of a molding machine by a gear pump. 0.003 wt % of trisnonylphenyl phosphite was added before the gear pump and the resulting mixture was melt extruded into the form of a sheet having a thickness of 2 mm or 0.2 mm and a width of 800 mm by sandwiching between a mirror cooling roll and a mirror roll or touching one side.

A visible light curable plastic adhesive (BENEFIX PC of Ardel Co., Ltd.) was applied to one side of the obtained aromatic polycarbonate sheet (thickness of 2 mm), and two of the obtained sheet were laminated ensuring to be extruded in one direction such that air bubbles were not contained between the sheets and exposed to 5,000 mJ/cm² light from a light curing device equipped with a metal halide lamp for irradiating visible light to obtain a laminated sheet. When the bonding strength of the obtained laminated sheet was measured in accordance with JIS K-6852 (method for testing the compression shear bonding strength of an adhesive), the bonding strength was satisfactory at 10.2 MPa (104 kgf/cm²).

A uniform solution of ink (Natsuda 70-9132: 136D smoke color) and a solvent (isophorone/cyclohexane/isobutanol=40/40/20 (wt %)) was printed on the 0.2 mm thick aromatic polycarbonate sheet by a silk screen printer and dried at 100° C. for 60minutes. The printed ink surface was satisfactory without a transfer failure.

Separately, 30 parts of a polycarbonate resin (specific viscosity of 0.895, Tg of 175° C.) obtained by carrying out a general interfacial polycondensation reaction between 1,1-bis(4-hydroxyphenyl)cyclohexane and phosgene, 15 parts of Plast Red 8370 (of Arimoto Kagaku Kogyo Co., Ltd.) as a dye and 130 part of dioxane as a solvent were mixed together to obtain printing ink. A sheet (0.2 mm thick) printed with the above printing ink was set in an injection mold and insert molding was carried out using a polycarbonate resin pellet (Panlite L-1225 of Teijin Chemicals, Ltd.) at 310° C. The printed portion of the obtained insert molded article had no abnormalities such as bleeding and blurring in pattern and had a good appearance.

### Evaluation of Polymer Blend Compound

### Examples 18 to 24

500 ppm of glycerol monostearate was added to the aromatic polycarbonate of the above Example 5. This composition had a magnetic field peak at 3,290 G, a total radical amount of 200 and a radical concentration of 300×10¹² per g. Further, 0.003 wt % of trisnonylphenyl phosphite, 0.05 wt % of trimethyl phosphate and components denoted by the following symbols in Tables 4 and 5 were added to 100 wt % of the composition, mixed uniformly by a tumbler and pelletized with a 30 mm-diameter vented twin-screw extruder (KTX-30 of Kobe Steel Co., Ltd.) at a cylinder temperature of 260° C. and a vacuum degree of 1.33 kPa (10 mmHg) under deaeration. The obtained pellets were dried at 120° C. for 5 hours and molded using an injection molding machine (Model SG150U of Sumitomo Heavy Industries, Ltd.) at a cylinder temperature of 270° C. and a mold temperature of 80° C. to form molded pieces for measurement. The following evaluations were made on these molded pieces. The results are shown in Tables 4 and 5.

(1)-1 ABS: styrene-butadiene-acrylonitrile copolymer; Suntac UT-61; Mitsui Chemicals, Inc.

(1)-2 AS: styrene-acrylonitrile copolymer; Stylac-AS 767 R27; Asahi Chemical Industry, Co., Ltd.

(1)-3 PET: polyethylene terephthalate; TR-8580; Teijin Limited, intrinsic viscosity of 0.8

(1)-4 PBT: polybutylene terephthalate; TRB-H; Teijin Limited, intrinsic viscosity of 1.07

(2)-1 MBS: methyl (meth)acrylate-butadiene-styrene copolymer; Kaneace B-56; Kanegafuchi Chemical Industry Co., Ltd.

(2)-2 E-1: butadiene-alkylacrylate-alkylmethacrylate copolymer; Paraloid EXL-2602; Kureha Chemical Industry, Co., Ltd.

(2)-3 E-2: composite rubber having a network structure that a polyorganosiloxane component and a polyalkyl (meth) acrylate rubber component penetrate into each other; Metabrene S-2001; Mitsubishi Rayon Co., Ltd.

(3)1 T: talc; HS-T0.8; Hayashi Kasei Co., Ltd., average particle diameter L of 5 μm measured by laser diffraction method, L/D of 8

(3)-2 G: glass fiber; chopped strand ECS-03T-511; Nippon Electric Glass Co., Ltd., urethane bundling, fiber diameter of 13 μm

(3)-3 W: wollastonite; Saikatec NN-4; Tomoe Kogyo Co., Ltd., number average fiber diameter D obtained from observation through electron microscope of 1.5 μm, average fiber length of 17 μm, aspect ratio L/D of 20

(4) WAX: olefin-based wax obtained by copolymerizing α-olefin and maleic anhydride; Diacalna P30; Mitsubishi Kasei Co., Ltd. (maleic anhydride content of 10 wt %)

### Measurement Methods

(A) Flexural Modulus

The flexural modulus was measured in accordance with ASTM D-790.

(B) Notched Impact Value

The impact value was measured by colliding a weight with a 3.2 mm thick test sample from the notch side in accordance with ASTM D-256.

(C) Fluidity

The fluidity was measured by an Archimedes type spiral flow tester (thickness of 2 mm, width of 8 mm) at a cylinder temperature of 250° C., a mold temperature of 80° C. and an injection pressure of 98.1 MPa.

(D) Chemical Resistance

1% strain was applied to a tensile test piece used in ASTM D-638 which was then immersed in Esso regular gasoline heated at 30° C. for 3 minutes to measure the tensile strength and calculate the tensile strength retention of the test piece. The retention was calculated from the following equation. retention (%)=(strength of processed sample/strength of unprocessed sample)×100

TABLE 4

| | | | Ex. 18 | Ex. 19 | Ex. 20 | Ex. 21 |
|---|---|---|---|---|---|---|
| composition | polycarbonate of Example 5 | wt % | 60 | 60 | 60 | 60 |
| | ABS | wt % | 40 | 40 | 40 | — |
| | AS | wt % | — | — | — | 30 |
| | MBS | wt % | — | — | — | 10 |
| | total | parts by weight | 100 | 100 | 100 | 100 |
| | G | parts by weight | 15 | — | — | 15 |
| | W | parts by weight | — | 15 | — | — |
| | T | parts by weight | — | — | 15 | — |
| | WAX | parts by weight | — | — | 1 | — |
| characteristic | flexural modulus | Mpa | 3450 | 3200 | 2900 | 3300 |
| properties | fluidity | cm | 30 | 27 | 29 | 34 |
| | notched impact value | J/M | 75 | 70 | 50 | 85 |

Ex.: Example

TABLE 5

| | | | Ex. 22 | Ex. 23 | Ex. 24 |
|---|---|---|---|---|---|
| composition | polycarbonate of Example 5 | wt % | 70 | 70 | 70 |
| | PBT | wt % | — | 30 | 5 |
| | PET | wt % | — | — | 25 |
| | total | parts by weight | 100 | 100 | 100 |
| | E-1 | parts by weight | 5 | 5 | — |
| | E-2 | parts by weight | — | — | 5 |
| | G | parts by weight | 20 | — | — |
| | W | parts by weight | — | 10 | — |
| | T | parts by weight | — | — | 10 |
| | WAX | parts by weight | — | 1 | 1 |
| characteristic | flexural modulus | Mpa | 5770 | 3560 | 3400 |
| properties | fluidity | % | 89 | 85 | 83 |
| | notched impact value | J/M | 75 | 70 | 50 |

Ex.: Example

1. An aromatic polycarbonate which comprises (A) a recurring unit represented by the following formula (a): 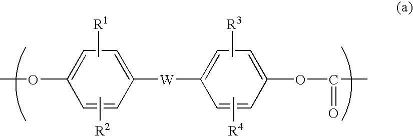
wherein R¹, R², R³ and R⁴ are each independently a hydrogen atom, halogen atom, alkyl group having 1 to 10 carbon atoms, aryl group having 6 to 10 carbon atoms, cycloalkyl group or aralkyl group having 7 to 10 carbon atoms, and W is an alkylene group having 1 to 6 carbon atoms, alkylidene group having 2 to 10 carbon atoms, cycloalkylene group having 6 to 10 carbon atoms, cycloalkylidene group having 6 to 10 carbon atoms, alkylene-arylene-alkylene group having 8 to 15 carbon atoms, oxygen atom, sulfur atom, sulfoxide group, sulfone group or single bond, as a main recurring unit,
and which has (B) a viscosity-average molecular weight of 10,000 to 100,000, (C) terminal groups consisting essentially of an aryloxy group and a phenolic hydroxyl group, the molar ratio of the aryloxy group to the phenolic hydroxyl group being 97/3 to 40/60, (D) a melt viscosity stability of 0.5% or less, and (E1) a peak at 3,290±50 G in magnetic field, the (ΔI×(ΔH)²) value obtained from the height (ΔI) of this peak and a magnetic field difference (ΔH) between the bottom of the peak and the top of the peak being 500 or less.

2. The aromatic polycarbonate of claim 1 which is obtained by melt polymerizing an aromatic dihydroxy compound and a carbonic acid diester in the presence of an ester exchange catalyst.

3. The aromatic polycarbonate of claim 1 which has a ΔI×(ΔH)² value of 700 or less after it is kept molten at 380° C. for 10 minutes.

4. The aromatic polycarbonate of claim 3 which is obtained by melt polymerizing an aromatic dihydroxy compound and a carbonic acid diester in the presence of at least one ester exchange catalyst selected from the group consisting of a lithium compound, rubidium compound and cesium compound.

5. An aromatic polycarbonate which comprises (A) a recurring unit represented by the following formula (a): 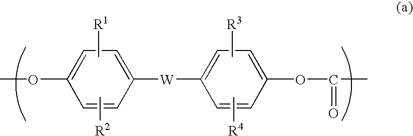
wherein R¹, R², R³ and R⁴ are each independently a hydrogen atom, halogen atom, alkyl group having 1 to 10 carbon atoms, aryl group having 6 to 10 carbon atoms, cycloalkyl group or aralkyl group having 7 to 10 carbon atoms, and W is an alkylene group having 1 to 6 carbon atoms, alkylidene group having 2 to 10 carbon atoms, cycloalkylene group having 6 to 10 carbon atoms, cycloalkylidene group having 6 to 10 carbon atoms, alkylene-arylene-alkylene group having 8 to 15 carbon atoms, oxygen atom, sulfur atom, sulfoxide group, sulfone group or single bond, as a main recurring unit,
and which has (B) a viscosity-average molecular weight of 10,000 to 100,000, (C) terminal groups consisting essentially of an aryloxy group and a phenolic hydroxyl group, the molar ratio of the aryloxy group to the phenolic hydroxyl group being 97/3 to 40/60, (D) a melt viscosity stability of 0.5% or less, and (E2) a radical concentration of 1×10¹⁵ or less (per g.polycarbonate).

6. The aromatic polycarbonate of claim 5 which has a radical concentration of 1×10¹² to 6×10¹⁴ (per g.polycarbonate).

7. The aromatic polycarbonate of claim 5 which is obtained by melt polymerizing an aromatic dihydroxy compound and a carbonic acid diester in the presence of an ester exchange catalyst.

8. The aromatic polycarbonate of claim 5 which has a radical concentration of 2×10¹⁵ or less (per g.polycarbonate) after it is kept molten at 380° C. for 10 minutes.

9. The aromatic polycarbonate of claim 8 which is obtained by melt polymerizing an aromatic dihydroxy compound and a carbonic acid diester in the presence of at least one ester exchange catalyst selected from the group consisting of a lithium compound, rubidium compound and cesium compound.

10. An aromatic polycarbonate composition comprising:
(1) 100 parts by weight of an aromatic polycarbonate which comprises (A) a recurring unit represented by the following formula (a): 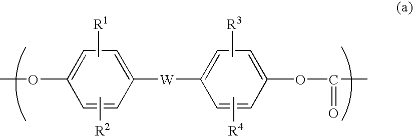
wherein R¹, R ², R³ and R⁴ are each independently a hydrogen atom, halogen atom, alkyl group having 1 to 10 carbon atoms, aryl group having 6 to 10 carbon atoms, cycloalkyl group or aralkyl group having 7 to 10 carbon atoms, and W is an alkylene group having 1 to 6 carbon atoms, alkylidene group having 2 to 10 carbon atoms, cycloalkylene group having 6 to 10 carbon atoms, cycloalkylidene group having 6 to 10 carbon atoms, alkylene-arylene-alkylene group having 8 to 15 carbon atoms, oxygen atom, sulfur atom, sulfoxide group, sulfone group or single bond, as a main recurring unit,
and which has (B) a viscosity-average molecular weight of 10,000 to 100,000, (C) terminal groups consisting essentially of an aryloxy group and a phenolic hydroxyl group, the molar ratio of the aryloxy group to the phenolic hydroxyl group being 97/3 to 40/60 and (D) a melt viscosity stability of 0.5% or less; and
(2) 5×10⁻³ to 2×10⁻¹ part by weight of a partial ester of a higher fatty acid having 8 to 25 carbon atoms and a polyhydric alcohol;
and having (3)-1 a peak at 3,290±50 G in magnetic field, the (ΔI×(ΔH)²) value obtained from the height (ΔI) of this peak and a magnetic field difference (ΔH) between the bottom of the peak and the top of the peak being 650 or less, and (4)-1 a (ΔI×(ΔH)²) value of 800 or less after it is kept molten at 380° C. for 10 minutes.

11. The aromatic polycarbonate composition of claim 10, wherein the aromatic polycarbonate is obtained by melt polymerizing an aromatic dihydroxy compound and a carbonic acid diester in the presence of at least one ester exchange catalyst selected from the group consisting of a lithium compound, rubidium compound and cesium compound.

12. The aromatic polycarbonate composition of claim 10 which further comprises 1×10⁻⁷ to 1×10⁻² part by weight of a bluing agent.

13. The aromatic polycarbonate composition of claim 10 which further comprises 1 to 150 parts by weight of a solid filler.

14. The aromatic polycarbonate composition of claim 10 which further comprises 10 to 150 parts by weight of a thermoplastic resin different from the above aromatic polycarbonate.

15. An aromatic polycarbonate composition comprising:
(1) 100 parts by weight of an aromatic polycarbonate which comprises (A) a recurring unit represented by the following formula (a): 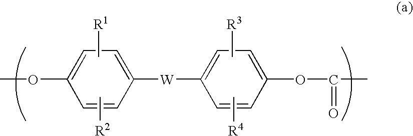
wherein R¹, R 2, R3 and R4 are each independently a hydrogen atom, halogen atom, alkyl group having 1 to 10 carbon atoms, aryl group having 6 to 10 carbon atoms, cycloalkyl group or aralkyl group having 7 to 10 carbon atoms, and W is an alkylene group having 1 to 6 carbon atoms, alkylidene group having 2 to 10 carbon atoms, cycloalkylene group having 6 to 10 carbon atoms, cycloalkylidene group having 6 to 10 carbon atoms, alkylene-arylene-alkylene group having 8 to 15 carbon atoms, oxygen atom, sulfur atom, sulfoxide group, sulfone group or single bond, as a main recurring unit,
and which has (B) a viscosity-average molecular weight of 10,000 to 100,000, (C) terminal groups consisting essentially of an aryloxy group and a phenolic hydroxyl group, the molar ratio of the aryloxy group to the phenolic hydroxyl group being 97/3 to 40/60 and (D) a melt viscosity stability of 0.5% or less, and
(2) 5×10⁻³ to 2×10⁻¹ part by weight of a partial ester of a higher fatty acid having 8 to 25 carbon atoms and a polyhydric alcohol;
and having (3)-2 a radical concentration of 1×10¹⁵ or less (per g.polycarbonate) and (4)-2 a radical concentration of 2×10¹⁵ or less (per g polycarbonate) after it is kept molten at 380° C. for 10 minutes.

16. The aromatic polycarbonate composition of claim 15, wherein the aromatic polycarbonate is obtained by melt polymerizing an aromatic dihydroxy compound and a carbonic acid diester in the presence of at least one ester exchange catalyst selected from the group consisting of a lithium compound, rubidium compound and cesium compound.

17. The aromatic polycarbonate composition of claim 15 which further comprises 1×10⁻⁷ to 1×10⁻² part by weight of a bluing agent.

18. The aromatic polycarbonate composition of claim 15 which further comprises 1 to 150 parts by weight of a solid filler.

19. The aromatic polycarbonate composition of claim 15 which further comprises 10 to 150 parts by weight of a thermoplastic resin different from the above aromatic polycarbonate.

20. An optical disk substrate comprising the aromatic polycarbonate of claim 1 and having a (ΔI)×(ΔH)² value of 500 or less.

21. An optical disk substrate comprising the aromatic polycarbonate of claim 5 and having a radical concentration of 1×10¹⁵ or less per g.

22. An optical disk substrate comprising the aromatic polycarbonate composition of claim 10 and having a (ΔI)×(ΔH)² value of 650 or less.

23. An optical disk substrate comprising the aromatic polycarbonate composition of claim 15 and having a radical concentration of 1×10¹⁵ or less per g.

24. Use of the aromatic polycarbonate of claim 1 or 5 as a raw material for an optical disk substrate.

25. Use of the aromatic polycarbonate composition of claim 10 or 15 as a raw material for an optical disk substrate.
